(19) United States
(12) Patent Application Publication
(10) Pub. No.: US 2026/0143288 A1
(43) Pub. Date: May 21, 2026

(54) SWITCHING LATENCY IN EAR-WORN DEVICES IMPLEMENTING NEURAL NETWORKS

(71) Applicant: Fortell Research Inc., New York, NY (US)

(72) Inventors: Igor Lovchinsky, New York, NY (US); Israel Malkin, Manhattan Beach, CA (US); Philip Meyers IV, Brooklyn, NY (US); Nathan Agmon, New York, NY (US); Nicholas Morris, Brooklyn, NY (US)

(21) Appl. No.: 19/394,655

(22) Filed: Nov. 19, 2025

Related U.S. Application Data
(60) Provisional application No. 63/722,619, filed on Nov. 20, 2024.
(60) Provisional application No. 63/738,381, filed on Dec. 23, 2024.

(51) Int. Cl. H04R 25/00; G06N 3/04

(52) U.S. Cl. CPC H04R 25/507; G06N 3/04; H04R 2460/01

(57) ABSTRACT

Described herein is an ear-worn device that may include processing circuitry and control circuitry. The processing circuitry may include neural network circuitry configured to implement one or more first neural network layers or one or more second neural network layers. The control circuitry may be configured to control the processing circuitry to operate using a first configuration or a second configuration. The neural network circuitry may be configured to implement the one or more first neural network layers when the processing circuitry operates using the first configuration, and the first configuration may have a first data processing latency. The neural network circuitry may be configured to implement the one or more second neural network layers when the processing circuitry operates using the second configuration, and the second configuration may have a second data processing latency different from the first data processing latency.

### BACKGROUND

### Field

The present disclosure relates to ear-worn devices. Some aspects relate to switching latency in ear-worn devices implementing neural networks.

### Related Art

Ear-worn devices, such as hearing aids, may be used to help those who have trouble hearing to hear better. Typically, ear-worn devices amplify received sound. Some ear-worn devices may attempt to reduce noise in received sound.

### SUMMARY

Reducing noise in the output of ear-worn devices (e.g., hearing aids, cochlear implants, and earphones) is a difficult challenge. Recently, neural networks for separating speech from noise have been developed. Further description of such neural networks for reducing noise may be found in U.S. Pat. No. 11,812,225, titled “Method, Apparatus and System for Neural Network Hearing Aid,” issued Nov. 7, 2023, which is incorporated by reference herein in its entirety. Processing circuitry implementing a neural network on an ear-worn device may be configured to operate at a certain data processing latency. Longer latencies may enable neural networks to provide higher quality output because longer latencies may mean that a neural network sees more data about what happened after a given input segment when determining how to process the segment (i.e., the model can “look farther into the future”). However, longer latencies may provide poorer wearer experience, particularly due to the lag between when the wearer speaks and when the wearer hears the processed version of their own voice output by the ear-worn device.

The inventors have recognized that longer latencies may be more tolerable in noisier environments. Thus, the inventors have developed technology that switches from a first configuration having a first latency to a second configuration having a second latency, where the latencies are different. Each configuration may use a different neural network. The configuration having the longer latency may be preferable for use in noisier environments, while the configuration having the shorter latency may be preferable for use otherwise. In some embodiments, the ear-worn device may switch from the first configuration to the second configuration based on user selection. In some embodiments, the ear-worn device may switch from the first configuration to the second configuration based on monitoring the environment (e.g., based on the ambient volume of the environment, or based on the signal-to-noise ratio (SNR)) or detecting own-voice.

### BRIEF DESCRIPTION OF DRAWINGS

FIG. 1 illustrates an ear-worn device, in accordance with certain embodiments described herein;

FIG. 2 illustrates a system including the ear-worn device of FIG. 1 and a processing device, in accordance with certain embodiments described herein;

FIG. 3 illustrates the processing circuitry of FIG. 1 in more detail, in accordance with certain embodiments described herein;

FIG. 4 illustrates the audio enhancement circuitry of FIG. 1 in more detail, in accordance with certain embodiments described herein;

FIG. 5 illustrates an example of training a neural network to generate a mask, in accordance with certain embodiments described herein;

FIG. 6 illustrates a portion of the audio enhancement circuitry of FIG. 1 in more detail, in accordance with certain embodiments described herein;

FIG. 7 illustrates processing of overlapping frames of data, in accordance with certain embodiments described herein;

FIG. 8 illustrates processing of overlapping frames of data, in accordance with certain embodiments described herein;

FIG. 9 illustrates processing of overlapping frames of data, in accordance with certain embodiments described herein;

FIG. 10 illustrates processing of overlapping frames of data, in accordance with certain embodiments described herein;

FIG. 11 illustrates processing of overlapping frames of data, in accordance with certain embodiments described herein;

FIG. 12 illustrates an example of how the values of weights may transition over time during a transition period, in accordance with certain embodiments described herein;

FIG. 13 illustrates an example of how the values of weights may transition over time during a transition period, in accordance with certain embodiments described herein

FIG. 14 illustrates an example of processing overlapping frames of data, in accordance with certain embodiments described herein;

FIG. 15 illustrates an example of processing overlapping frames of data, in accordance with certain embodiments described herein;

FIG. 16 illustrates a method for switching latency, in accordance with certain embodiments described herein;

FIG. 17 illustrates a method for switching latency, in accordance with certain embodiments described herein; and

FIG. 18 illustrates a hearing aid, in accordance with certain embodiments described herein.

### DETAILED DESCRIPTION

The aspects and embodiments described above, as well as additional aspects and embodiments, are described further below. These aspects and/or embodiments may be used individually, all together, or in any combination of two or more, as the disclosure is not limited in this respect.

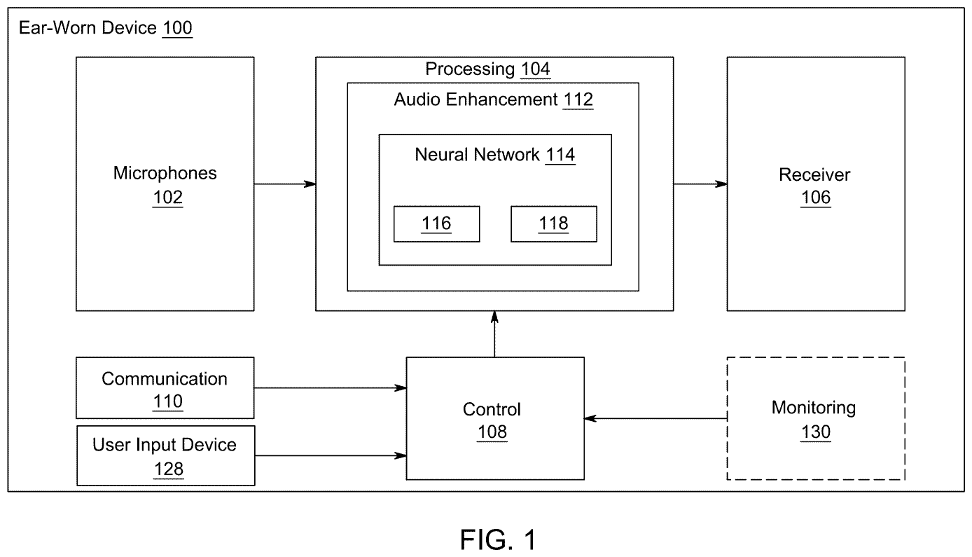

FIG. 1 illustrates an ear-worn device 100, in accordance with certain embodiments described herein. The ear-worn device 100 may be, for example, a hearing aid, a cochlear implant, or an earphone. The ear-worn device 100 includes one or more microphones 102, processing circuitry 104, a receiver 106, control circuitry 108, communication circuitry 110, a user input device 128, and monitoring circuitry 130. The processing circuitry 104 includes audio enhancement circuitry 112. The audio enhancement circuitry 112 includes neural network circuitry 114. The neural network circuitry 114 may be configured to implement one or more neural network layers 116 or one or more neural network layers 118. In the other words, the neural network circuitry 114 may be configured to implement the one or more neural network layers 116 during one time period and the one or more neural network layers 118 during a second time period. (As referred to in the description and claims, implementing the one or more neural network layers 116 or the one or more neural network layers 118 should be understood to mean implementing at least the one or more neural network layers 116 or the one or more neural network layers 118. In other words, there may be more than two sets of neural network layers that the neural network circuitry 114 may be configured to implement.)

The one or more microphones 102 may include one, two, or more than two (e.g., 3, 4, or more) microphones. For example, the one or more microphones 102 may include two microphones, a front microphone that is closer to the front of the wearer of the ear-worn device 100 and a back microphone that is closer to the back of the wearer of the ear-worn device 100. As another example, the one or more microphones 102 may include more than two microphones in an array. Microphones in an array may be linked via wireless communication (e.g., the microphones may be disposed on two different ear-worn devices configured for binaural communication). The one or more microphones 102 may be configured to receive sound signals and to generate audio signals from the sound signals.

The processing circuitry 104 may be configured to process the signals from the one or more microphones 102. Further description of the processing circuitry 104 will be provided below.

The receiver 106 may be configured to play back the output of the processing circuitry 104 as sound into the ear of the user. The receiver 106 may also be configured to implement digital-to-analog conversion prior to the playing back.

The control circuitry 108 may be configured to control operation of the ear-worn device 100. While FIG. 1 illustrates the control circuitry 108 communicating with the processing circuitry 104, it should be appreciated that the control circuitry 108 may be configured to control operations of other components of the ear-worn device 100 as well. As will be described further below, the control circuitry 108 may be configured to control the processing circuitry 104 to operate using a first configuration or a second configuration. (As referred to in the description and claims, operating using a first configuration or a second configuration should be understood to mean operating using at least a first configuration or a second configuration. In other words, there may be more than two configurations in which the processing circuitry 104 may operate.) When the processing circuitry 104 operates using the first configuration, the neural network circuitry 114 may be configured to implement the one or more neural network layers 116. When the processing circuitry 104 operates using the second configuration, the neural network circuitry 114 may be configured to implement the one or more neural network layers 118. In some embodiments, the first configuration may have a first data processing latency and the second configuration may have a second data processing latency different from the first data processing latency. In some embodiments, the first configuration and the second configuration may have the same data processing latency.

The user input device 128 may be configured to receive a user input. For example, the user input device 128 may be any type of device on an ear-worn device 100 that is configured to receive a user input, such as a button, a dial, a rocker switch, a slider switch, a touch-sensitive area, or a microphone.

The monitoring circuitry 130 may be configured to monitor the environment of the ear-worn device 100. For example, the monitoring circuitry 130 may be configured to measure the ambient volume of the environment. As another example, the monitoring circuitry 130 may be configured to measure the signal-to-noise ratio (SNR) of the environment. To measure SNR, the monitoring circuitry 130 may be configured to use one or more signals generated by the audio enhancement circuitry 112, which may include speech-and noise-isolated components of audio signals received by the one or more microphones 102. As another example, the monitoring circuitry 130 may be configured to perform own-voice detection. In embodiments that do not perform environmental monitoring, the monitoring circuitry 130 may be absent.

The communication circuitry 110 may be configured to facilitate communication between the ear-worn device 100 and other devices (e.g., a processing device such as a smartphone or tablet, which may be the processing device 220), for example over wireless communication links (e.g., Bluetooth or near-field magnetic induction (NFMI)). When the communication circuitry 110 is configured to facilitate NFMI communication, the communication circuitry 110 may include a magnetic induction transceiver and supporting control, audio processing, and power management circuitry. When the communication circuitry 110 is configured to facilitate Bluetooth communication, the communication circuitry 110 may include a transceiver (e.g., a 2.4 GHz transceiver) and supporting control, audio processing, and power management circuitry.

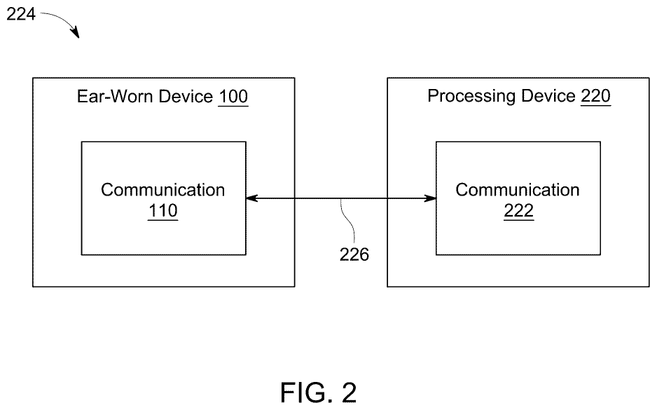

FIG. 2 illustrates a system 224 including the ear-worn device 100 and a processing device 220, in accordance with certain embodiments described herein. The processing device 220 may be, for example, a smartphone or a tablet, and may correspond to any of the processing devices described herein. The processing device 220 includes communication circuitry 222. Further description of communication circuitry may be found with reference to the communication circuitry 110. As illustrated, the communication circuitry 110 of the ear-worn device 100 and the communication circuitry 222 of the processing device 220 may be configured to facilitate communication between the ear-worn device 100 and the processing device 220 over a wireless communication link 226, such as a Bluetooth communication link or an NFMI communication link.

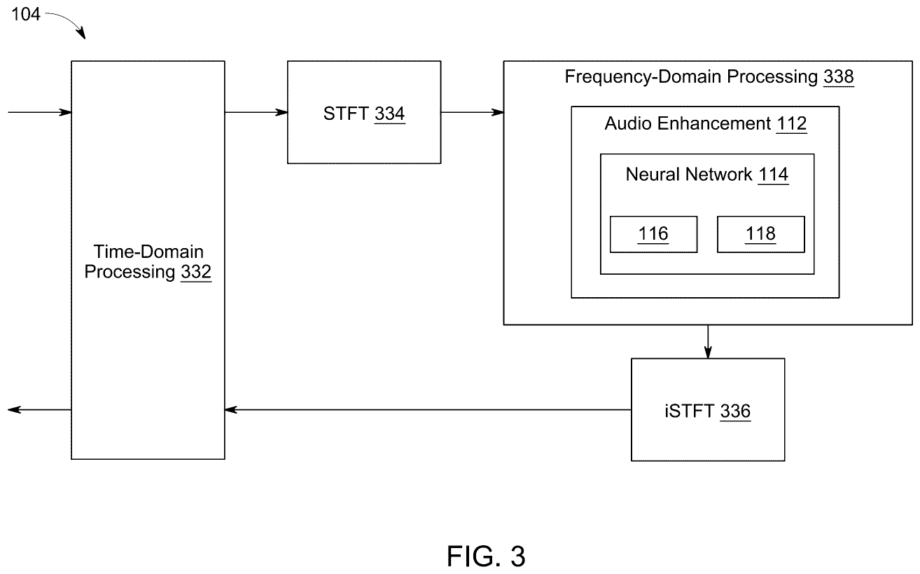

FIG. 3 illustrates the processing circuitry 104 of FIG. 1 in more detail, in accordance with certain embodiments described herein. The processing circuitry 104 includes time-domain processing circuitry 332, short-time Fourier transformation (STFT) circuitry 334, frequency-domain processing circuitry 338, and inverse STFT circuitry 336. The frequency-domain processing circuitry 338 includes the audio enhancement circuitry 112. The audio enhancement circuitry 112 includes the neural network circuitry 114. The neural network circuitry 114 may be configured to implement either the one or more neural network layers 116 or the one or more neural network layers 118.

The time-domain processing circuitry 332 may be configured to receive audio signals from the one or more microphones 102 (not illustrated in FIG. 3) and perform time-domain processing. For example, the time-domain processing may include input calibration and anti-feedback processing (although one or both of these may be performed by the frequency-domain processing circuitry 338 in some embodiments). The STFT circuitry 334 may be configured to convert short windows of time-domain signals into the frequency domain. The frequency-domain processing circuitry 338 may be configured to perform frequency-domain processing, including audio enhancement (as performed by the audio enhancement circuitry 112). As examples, the frequency-domain processing may also include wind reduction and wide dynamic range compression (WDRC) (although one or both of these may be performed by the time-domain processing circuitry 332 in some embodiments). The iSTFT circuitry 336 may be configured to convert audio signals from the frequency domain back to the time domain. The time-domain processing circuitry 332 may then be configured to perform further time-domain processing, such as output calibration, prior to generating an output audio signal (although output calibration may be performed by the frequency-domain processing circuitry 338 in some embodiments).

Returning to the audio enhancement circuitry 112, generally the audio enhancement circuitry 112 may be configured to perform audio enhancement. In some embodiments the audio enhancement circuitry 112 may be configured to perform background noise reduction. In some embodiments, the audio enhancement circuitry 112 may be configured to perform spatial focusing. In some embodiments, the audio enhancement circuitry 112 may be configured to perform background noise reduction and spatial focusing. The audio enhancement circuitry 112 may be configured to use the one or more neural network layers 116 or the one or more neural network layers 118, implemented by the neural network circuitry 114, to perform the background noise reduction and/or spatial focusing. In particular, the one or more neural network layers 116 and the one or more neural network layers 118 may be trained to generate one or more outputs, such as a mask, configured to generate audio signals having reduced background noise and/or having spatial focus.

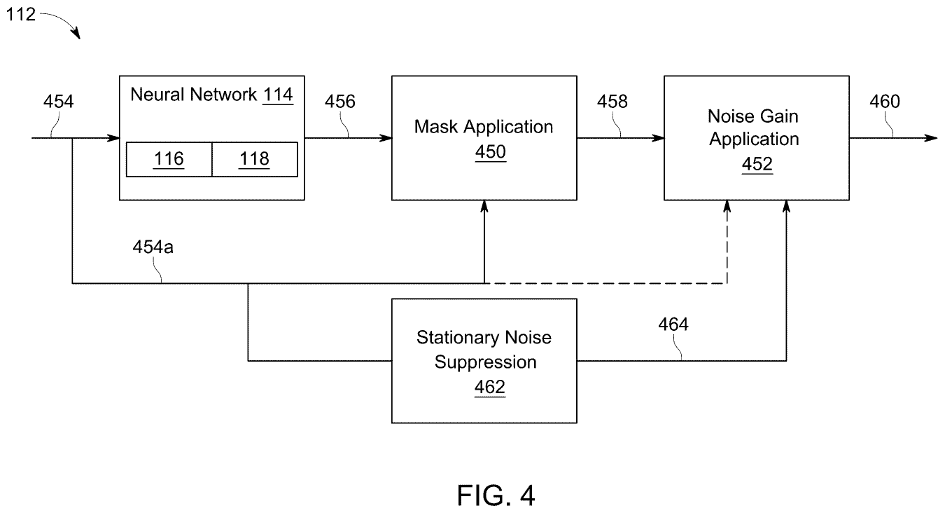

FIG. 4 illustrates the audio enhancement circuitry 112 in more detail, in accordance with certain embodiments described herein. The audio enhancement circuitry 112 includes neural network circuitry 114, mask application circuitry 450, noise gain application 452, and stationary noise suppression (SNS) circuitry 462. Generally, the neural network circuitry 114 may be configured to receive one or more audio signals 454 and implement one or more neural network layers (e.g., either the one or more neural network layers 116 or the one or more neural network layers 118) trained to perform audio enhancement, such as noise reduction and/or spatial focusing, based on the one or more audio signals 454.

Thus, in some embodiments, the one or more neural network layers implemented by the neural network circuitry 114 may be trained to reduce noise. In such embodiments, one of the one or more neural network outputs 456 from the neural network circuitry 114 may be a version of one of the one or more audio signals 454 (e.g., the audio signal 454a) that has less noise (or just speech), an output (e.g., a mask) configured to generate a version of one of the one or more audio signals 454 (e.g., the audio signal 454a) that has less noise (or just speech), a version of one of the one or more audio signals 454 (e.g., the audio signal 454a) that has less speech (or just noise), or an output (e.g., a mask) configured to generate a version of one of the one or more audio signals 454 (e.g., the audio signal 454a) that has less speech (or just noise).

In some embodiments, the one or more neural network layers implemented by the neural network circuitry 114 may be trained to perform spatial focusing. In such embodiments, one of the one or more neural network outputs 456 from the neural network circuitry 114 may be a spatially-focused version of one of the one or more audio signals 454 (e.g., the audio signal 454a), or an output (e.g., a mask) configured to generate the spatially-focused version of one of the one or more audio signals 454 (e.g., the audio signal 454a).

In some embodiments, the one or more neural network layers implemented by the neural network circuitry 114 may be trained to both reduce noise and perform spatial focusing. In such embodiments, one of the one or more neural network outputs 456 from the neural network circuitry 114 may be a noise-reduced and spatially-focused version of one of the one or more audio signals 454 (e.g., the audio signal 454a), or an output (e.g., a mask) configured to generate the noise-reduced and spatially-focused version of one of the one or more audio signals 454 (e.g., the audio signal 454a). It should be appreciated that in some embodiments, one neural network layer may be trained to reduce noise, perform spatial focusing, or both reduce noise and perform spatial focusing. In some embodiments, multiple neural network layers may be trained to reduce noise, perform spatial focusing, or both reduce noise and perform spatial focusing. It should also be appreciated that, as described above, the neural network circuitry 114 may be trained to generate a mask configured to generate a noise-reduced and/or spatially-focused audio signal. In other words, the mask may be a noise-reducing mask, a spatially-focusing mask, or a noise-reducing and spatially-focusing mask.

This description may describe one or more neural network layers that are trained to perform a certain action, or to generate an output for use in performing that action. As referred to herein, one or more neural network layers may be considered trained to perform a certain action if the one or more neural network layers perform that action themselves, or if they generate output for use in performing that action. Thus, it should be appreciated that one or more neural network layers may be considered trained to perform noise reduction even if the one or more neural network layers themselves do not generate a noise-reduced audio signal; one or more neural network layers that generate a mask (or generally, an output) configured to be used to generate a noise-reduced audio signal may still be considered trained to perform noise reduction. In some embodiments, the mask may be used to isolate a speech component of an input signal. In some embodiments, the mask may be used to isolate a noise component of an input signal. In some embodiments, the output may be the speech component or the noise component itself. In any such embodiments, (and as described further below), the resulting component (speech or noise) may be used to generate an output signal having less noise than the input signal, and thus the one or more neural networks may be referred to as trained to perform noise reduction. It should also be appreciated that one or more neural network layers may be considered trained to perform spatial focusing even if the one or more neural network layers themselves do not generate a spatially-focused audio signal; one or more neural network layers that generate an output configured to be used to generate a spatially-focused audio signal may still be considered trained to perform spatial focusing. The output may be, as a non-limiting example, a mask configured to generate a spatially-focused audio signal.

Any neural network layers described herein may be, for example, of the recurrent, vanilla/feedforward, convolutional, generative adversarial, attention (e.g. transformer), or graphical type. Generally, a neural network made up of such layers may include an initial layer, a plurality of intermediate layers, and a final layer, and the layers may be made up of a plurality of neurons/nodes to which neural network weights may be applied.

Generally, the neural network circuitry 114 may be configured to receive one or more audio signals 454. In some embodiments, the one or more audio signals 454 may include one signal. In some embodiments, the one or more audio signals 454 may include two signals. In some embodiments, the one or more audio signals 454 may include three signals. In some embodiments, the one or more audio signals 454 may include four signals. In some embodiments, the one or more audio signals 454 may include more than four signals. In some embodiments, the one or more audio signals 454 may be in the frequency domain. In some embodiments, the one or more audio signals 454 may be in the time domain. In some embodiments, the neural network circuitry 114 may be configured to receive the one or more audio signals 454 together (i.e., not one after another). In some embodiments, the neural network circuitry 114 may be configured to process the one or more audio signals 454 together (i.e., not one after another).

In some embodiments, certain of the one or more audio signals 454 may be beamformed. In some embodiments, two or more of the audio signals 454 may each have a different beamformed directional pattern. For example, one or more of the audio signals 454 may be front-facing and one or more of the audio signals 454 may be rear-facing. Front-facing beamformed signals may generally attenuate signals coming from behind the wearer more than signals coming from in front of the wearer, and back-facing beamformed signals may generally attenuate signals coming from in front of the wearer more than signals coming from behind the wearer. Example directional patterns include cardioids, supercardioids, hypercardioids, and dipoles. In some embodiments, the neural network circuitry 114 may instead be configured to receive non-beamformed audio signals, or a mix of beamformed and non-beamformed audio signals.

Prior to neural network processing, the neural network circuitry 114 may be configured to perform pre-processing on the one or more audio signals 454 (in addition to the STFT performed by the STFT circuitry 334). In some embodiments, the pre-processing may include feature extraction, which may include performing certain mathematical transformations such as taking the magnitude. In some embodiments, the pre-processing circuitry may include normalization.

As described above, in some embodiments, the neural network circuitry 114 may be configured to implement one or more neural network layers trained to perform audio enhancement such as noise reduction and/or spatial focusing, such that the neural network circuitry 114 generates, based on the one or more audio signals 454, one or more neural network outputs 456. (For simplicity, this description may interchangeably describe receiving signals and generating outputs based on the signals as performed by neural network circuitry or one or more neural network layers implemented by the neural network circuitry.) In some embodiments, the audio enhancement circuitry 112 may be configured to generate, based on the one or more neural network outputs 456, at least one of a noise-reduced version of the audio signal 454a (which is one of the one or more audio signals 454), a spatially-focused version of the audio signal 454a, or a noise-reduced and spatially-focused version of the audio signal 454a. Following will be a description of various methods by which the audio enhancement circuitry 112 may generate these signals based on the one or more neural network outputs 456.

In some embodiments, one of the one or more neural network outputs 456 may be a mask. A mask may be a real or complex mask that varies with frequency. Thus, when a mask is applied to (e.g., multiplied by, or added to) an audio signal (in the example of FIG. 4, the audio signal 454a), the mask may operate differently on different frequency components of the audio signal. In other words, the mask may cause different frequency components of the audio signal to be multiplied by different real or complex values. A real mask may modify just magnitude, while a complex mask may modify both magnitude and phase. When the one or more neural network outputs 456 include two masks, the two masks may be different.

With further regards to training, in some embodiments one or more neural network layers implemented by the neural network circuitry 114 may be trained to perform noise reduction. Training such neural network layers may include obtaining noisy speech audio signals and speech-isolated versions of the audio signals (i.e., with only the speech remaining). In some embodiments, masks that, when applied to the noisy speech audio signals, result in the speech-isolated audio signals may be determined. The training input data may be the noisy speech audio signals and the training output data may be the masks. The one or more neural network layers may thereby learn how to output a speech-isolating mask for the audio signal 454a, such that when the mask is applied to (e.g., multiplied by or added to) the audio signal 454a, the resulting output audio signal is a speech-isolated version of the audio signal 454a. In some embodiments, masks that, when applied to the noisy speech audio signals, result in the noise-isolated audio signals may be determined. The training input data may be the noisy speech audio signal and the training output data may be the masks. The neural network layers may thereby learn how to output a noise-isolating mask for the audio signal 454a, such that when the mask is applied to (e.g., multiplied by or added to) the audio signal 454a, the resulting output audio signal is a noise-reduced version of the audio signal 454a. In embodiments in which the one or more neural networks are trained to output speech-isolated or noise-isolated signals themselves, the output training data may be the speech-isolated or noise-isolated signals themselves. Further description of neural networks trained to perform noise reduction may be found in U.S. Pat. No. 11,812,225, titled “Method, Apparatus and System for Neural Network Hearing Aid,” issued Nov. 7, 2023.

In some embodiments, one or more neural network layers implemented by the neural network circuitry 114 may be trained to perform spatial focusing. Spatial focusing may include applying a spatial focusing pattern to an audio signal. A spatial focusing pattern may specify different weights as a function of direction-of-arrival (DOA) of sounds, where DOA may be defined relative to the wearer of the ear-worn device. In some embodiments, weights may be equal to 0, equal to 1, or between 0 and 1. In some embodiments, weights may be equal to or greater than 0. In some embodiments, weights may be greater than 0, less than 0, equal to zero, or complex numbers; a negative weight may flip phase by 180 degrees, while a complex weight may rotate the phase by some angle. Mapping weights to DOA may result in focusing, as higher weights may be applied to sounds originating from certain directions and lower weights may be applied to sounds originating from other directions. For training such neural network layers, a training audio signal may be formed from component audio signals originating from different DOAs. Multiple audio signals originating from multiple microphones may be generated from the training audio signal. When the neural network is trained to output a mask, a training mask may be determined such that, when the training mask is applied to one of the multiple audio signals, what remains is each component audio signal multiplied by a weight corresponding to the DOA from which it originated, and then summed together. The one or more neural network layers may thereby learn how to output a mask based on multiple audio signals such that, when the mask is applied to (e.g., multiplied by or added to) to one of the signals (e.g., the audio signal 454a), the resulting output includes each component of the signal multiplied by a weight corresponding to the DOA from which it originated, and then summed together (e.g., resulting in a spatially-focused version of the audio signal 454a). In embodiments in which the one or more neural networks are trained to output spatially-focused signals, the output training data may be the spatially-focused signals themselves. Further description of neural networks for spatially focusing may be found in U.S. Pat. No. 11,937,047, entitled “Ear-Worn Device with Neural Network for Noise Reduction and/or Spatial Focusing Using Multiple Input Audio Signals” issued Mar. 19, 2024, which is incorporated by reference herein in its entirety.

In some embodiments, one or more neural network layers implemented by the neural network circuitry 114 may be trained to perform noise reduction and spatial focusing. For training such neural network layers, a training audio signal may be formed from component audio signals originating from different DOAs. Multiple audio signals originating from multiple microphones may be generated from the training audio signal. When the neural network is trained to output a mask, a training mask may be determined such that, when the training mask is applied to one of the multiple audio signals, what remains is the speech of each component audio signal multiplied by a weight corresponding to the DOA from which it originated, and then summed together. (As described above, training audio signals may include noisy speech audio signals and speech-isolated versions of the audio signals, i.e., with only the speech remaining.) The one or more neural network layers may thereby learn how to output a mask based on the multiple audio signals such that, when the mask is applied to (e.g., multiplied by or added to) the audio signal 454a, the resulting output includes the speech of each component of the audio signal 454a multiplied by a weight corresponding to the DOA from which it originated, and then summed together, namely a noise-reduced and spatially-focused version of the speech component of the audio signal 454a. In embodiments in which the one or more neural networks are trained to output noise-reduced and spatially-focused signals, the output training data may be the noise-reduced and spatially-focused signals themselves.

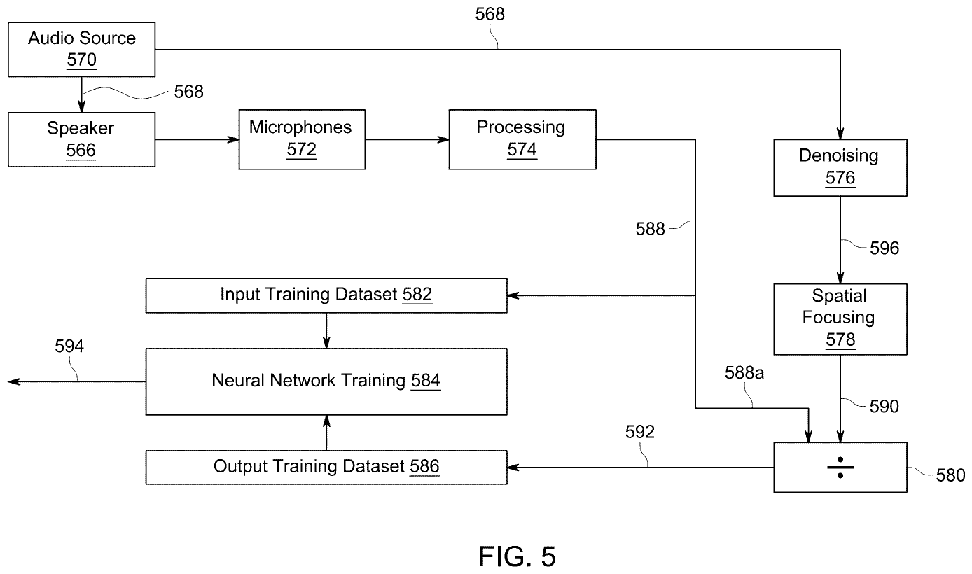

FIG. 5 illustrates an example of training a neural network to generate a mask, in accordance with certain embodiments described herein. FIG. 5 illustrates a speaker 566 configured to generate sound based on noisy audio 568 received from an audio source 570. The speaker 566 may be arranged at a particular orientation (e.g., angle and/or distance) relative to one or more microphones 572. As an example, the noisy audio 568 from the audio source 570 may include mixed speech and noise. In some embodiments, the microphones 572 may be arranged in a configuration matching that of ear-worn devices on a wearer, for example, with some of the microphones 572 (corresponding to an ear-worn device on one ear of a wearer) separated a distance from other of the microphones 572 (corresponding to an ear-worn device on the other ear of the wearer). This distance may be approximately equal to the distance between ears on a typical person. The speaker 566 and microphones 572 may be a real-word speaker and real-world microphones, or may be simulated in software. The output of the microphones 572, based on receiving the sound from the speaker 566, may undergo processing 574 to generate one or more processed audio signals 588, respectively. The one or more processed audio signals 588 may have undergone some or all of the same processing performed on an ear-worn device (e.g., the hearing aid 100 and/or ear-worn device 200) to generate its processed audio signals that will be inputted to the neural network being trained here.

The denoising 576 may generate a denoised (e.g., only speech-containing) version 596 of the noisy audio 568. In some embodiments, a denoising neural network may be configured to denoise the noisy audio 568 (e.g., only retain speech). In some embodiments, the noisy audio 568 may be part of a dataset in which the denoised version 596 of the noisy audio 568 is already available.

The spatial focusing 578 may apply a spatial focusing pattern to the denoised version 596 of the noisy audio 568, thereby generating a denoised and spatially-focused version 590 of the noisy audio 568. It should be appreciated that the denoised and spatially-focused version 590 of the noisy audio 568 may be obtained by multiplying the denoised version 596 of the noisy audio 568 by a weight, where the weight is determined from the spatial focusing pattern based on the orientation of the speaker 566 relative to the microphones 572. A spatial focusing pattern may, for example, define weight as a function of direction-of-arrival (DOA). Generally, weight may be greater for DOAs in front of the wearer vs. to the sides and back of the wearer.

The divider 580 may be configured to divide the denoised and spatially-focused version 590 of the noisy audio 568 by one of the audio signals 588, referred to here as the audio signal 588a. As a specific example, the audio signal 588a may be a front-facing audio signal, and may also be a beamformed audio signal (e.g., having a cardioid or supercardioid directional pattern, as non-limiting examples). The result may be a mask 592.

A dataset including the one or more processed audio signals 588 may be added to the input training data 582. The mask 592 may be added to the output training dataset 586. Many such sets of data may be generated by varying the orientation (e.g., angle and/or distance) of the speaker 566 relative to the microphones 572. Neural network training 584 may be performed on the input training dataset 582 and the output training dataset 586. Further description may be found in U.S. Pat. No. 11,812,225, titled “Method, Apparatus and System for Neural Network Hearing Aid,” issued Nov. 7, 2023, which is incorporated by reference herein in its entirety. Based on the neural network training 584, neural network weights 594 may be generated. A neural network using the weights 594 may be configured to generate, during inference (e.g., when running on an ear-worn device) a mask that can be used to generate a denoised and spatially-focused version of an audio signal. This may be the mask smoothed as described above.

While the above description of FIG. 5 has described neural networks trained to perform denoising and spatial focusing, and masks configured to generate denoised and spatially-focused audio signals, it should be appreciated that the neural network and mask might only be for denoising, or only for spatial focusing, and the appropriate portions of the training may be omitted.

Returning to FIG. 4, as described above, in some embodiments the neural network circuitry 114 may be configured to generate a mask that, when applied to (e.g., multiplied by or added to) the audio signal 454a, results in a certain other signal (e.g., a noise-reduced version of the audio signal 454a, a spatially-focused version of the audio signal 454a, or a noise-reduced and spatially-focused version of the audio signal 454). The mask may be one of the one or more neural network outputs 456. In some embodiments, the mask application circuitry 450 in the audio enhancement circuitry 112 may be configured to perform application of the mask to the audio signal 454a (e.g., using multiplication or addition).

In some embodiments, in addition to mask application, the mask application circuitry 450 may be configured to obtain one or more signals after the mask application. In some embodiments, subtraction may be used to obtain such signals, while in some embodiments other operations, such as addition, may be used instead. For example, consider that the mask application resulted in a speech component of the audio signal 454a. The mask application circuitry 450 may be configured to obtain the noise component of the audio signal 454a by subtracting the speech component from the audio signal 454a. As another example, consider that the mask application resulted in a noise component of the audio signal 454a. The mask application circuitry 450 may be configured to obtain the speech component of the audio signal 454a by subtracting the noise component from the audio signal 454a. As another example, consider that the mask application resulted in a speech component of the audio signal 454a that is spatially-focused in a target direction (which may be referred to as a target speech signal). The mask application circuitry 450 may be configured to obtain the speech component of the audio signal 454a spatially-focused in non-target directions (which may be referred to as an interfering speech signal) by subtracting the target speech component from the speech component. As another example, consider that the mask application resulted in the interfering speech component of the audio signal 454a. The mask application circuitry 450 may be configured to obtain the target speech component of the audio signal 454a by subtracting the interfering speech component from the speech component. The mask application circuitry 450 may be configured to output one or more audio signals 458, generated as described above.

The SNS circuitry 462 may be configured to receive the audio signal 454a, generate an estimate of its stationary noise component, and generate one or more SNS outputs 464. In some embodiments, the one or more SNS outputs 464 may include a mask, such that when the mask is applied (e.g., multiplied by or added to) the audio signal 454a, the result is a version of the audio signal 454a with a certain amount of stationary noise removed. In some embodiments, the SNS circuitry 462 may be configured to implement a minimum statistics noise estimation algorithm to generate the estimate of the stationary noise component of the audio signal 454a. In some embodiments, the SNS circuitry 462 may be further configured to implement other algorithms, in addition to or instead of the minimum statistics noise estimation algorithm, to generate the estimate of the stationary noise component of the audio signal 454a and/or to generate the mask. These algorithms may include, among non-limiting examples, spectral subtraction, Wiener filtering, and Ephraim-Malah techniques. Further description of such algorithms may be found in Chung, King. “Challenges and recent developments in hearing aids: Part I. Speech understanding in noise, microphone technologies and noise reduction algorithms.” Trends in Amplification 8.3 (2004): 83-124, which is incorporated by reference herein in its entirety.

In some embodiments, the noise gain application 452 may be configured to mix two or more audio signals. The two or more audio signals may include two or more audio signals 458 output by the mask application circuitry 450, one of the audio signals 458 and the audio signal 454a, or two or more audio signals 458 output by the mask application circuitry 450 and the audio signal 454a. As referred to herein, mixing should be understood to mean any combination of different elements after application of weights to the different elements. Thus, the noise gain application 452 may be configured to apply different weights to signals (e.g., by multiplication) and combine the results together (e.g., by addition). The mixing performed by the noise gain application 452 may also be considered interpolation. Different embodiments of the noise gain application 452 may be configured to mix together different combinations of audio signals (some or all of which may have been generated by the mask application circuitry 450). As non-limiting examples, the noise gain application 452 may be configured to mix together the speech component and the noise component of the audio signal 454a; the speech component of the audio signal 454a and the audio signal 454a itself; the noise component of the audio signal 454a and the audio signal 454a itself; or the target speech component, the interfering speech component, and the noise component of the audio signal 454a. As a specific example, referring to the speech component as speech and the noise component as noise, in some embodiments the noise gain application 452 may be configured to generate speech+weight_noise*noise, where weight_noise is the weight applied to the noise component. The weight weight_noise may be, for example, between 0 and 1. (For simplicity, no weight is described as applied to the speech component, but in some embodiments a weight may be applied to the speech component as well.) As another specific example, referring to the target speech component as target_speech, the interfering speech component as interfering speech, and the noise component as noise, in some embodiments the noise gain application 452 may be configured to generate target_speech+weight_int*interfering_speech+weight_noise*noise. The weights weight_int and weight_noise may be, for example, between 0 and 1. (For simplicity, no weight is described as applied to the target speech component, but in some embodiments a weight may be applied to the target speech component as well.) In embodiments in which the one or more SNS outputs 464 include a mask, the noise gain application circuitry 452 may be configured to apply (e.g., by multiplication or addition) the mask to the result of the mixing described above. For example, referring to the mask as mask_sns, the noise gain application circuitry 452 may be configured to generate as the output audio signal 460 the result (speech+weight_noise*noise)*mask_sns. As described above, the mask_sns may be configured to reduce stationary noise by a certain amount, or in other words, a stationary noise at a certain gain may remain.

In some embodiments, the one or more neural network outputs 456 may include audio signals themselves. In other words, the neural network circuitry 114 may be configured to directly output one or more audio signals themselves. In such embodiments, the mask application circuitry 450 may instead just include subtraction circuitry. In some embodiments, application of masks may result in all the signals that need to be generated. In such embodiments, the mask application circuitry 450 may instead just include mask application circuitry. In some embodiments, the neural network circuitry 114 may be configured to directly output all the signals that need to be generated. In such embodiments, the mask application circuitry 450 may be absent.

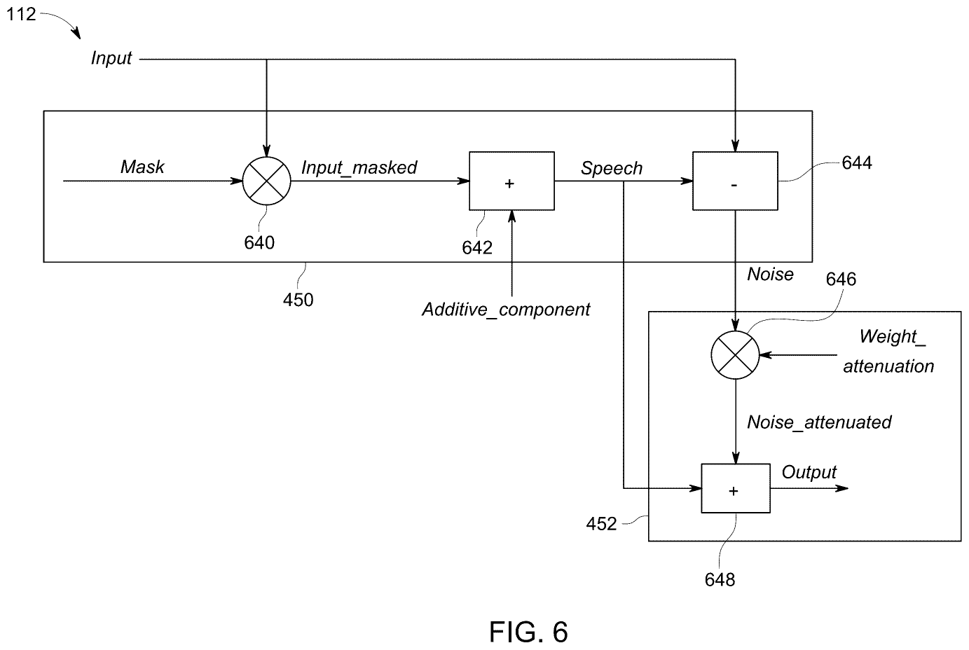

FIG. 6 illustrates a portion of the audio enhancement circuitry 122 in more detail, in accordance with certain embodiments described herein. FIG. 6 illustrates processing of a mask (referred to as mask) and an additive component (referred to as additive_component), which may be examples of the one or more neural network outputs 456. The multiplier 640 may be configured to multiply mask by an input audio signal (referred to as input, which may be one of the one or more audio signals 454), thereby generating a masked input (referred to as input_masked). However, in some embodiments, mask may be applied to input through other operations, such as addition. The adder 642 may be configured to add additive_component to input_masked, thereby generating a speech component of the input audio signal (referred to as speech). The subtractor 644 may be configured to subtract speech from input, thereby generating the noise component of the input audio signal (referred to as noise). However, in some embodiments, the application of mask and additive_component to input may result in noise, and the subtractor 644 may be configured to subtract noise from input, thereby generating speech. The multiplier 646 may be configured to multiply noise by an attenuation weight (referred to as weight_attenuation, e.g., a value between 0 and 1), thereby generating an attenuated version of the noise component (referred to as noise_attenuated). The adder 648 may be configured to add speech and noise_attenuated, thereby generating an output audio signal (referred to as output, which may correspond to an output audio signal 460). Thus, output may include the speech component and an attenuated version of the noise component of the input audio signal. Including some noise in the output audio signal may help to increase environmental awareness and reduce distortion. It should be appreciated that instead of adding the speech component and an attenuated version of the noise component, other operations may produce the equivalent result, such as adding weighted versions of the speech component and the input audio signal itself, or adding weighted versions of the noise component and the input audio signal itself.

The multiplier 640, the adder 642, and the subtractor 644 may constitute at least a portion of the mask application circuitry 450. The multiplier 646 and adder 648 may constitute at least a portion of the noise gain application circuitry 452.

Further description of neural networks, training neural networks, background noise reduction, and spatial focusing may be found in U.S. Pat. No. 11,937,047, titled “Ear-Worn Device with Neural Network for Noise Reduction and/or Spatial Focusing Using Multiple Input Audio Signals,” and issued Mar. 19, 2024, which is incorporated by reference herein in its entirety. As will be described below, the neural network circuitry 114 may be configured to use the one or more neural network layers 116 when operating in a first configuration and to use the one or more neural network layers 118 when operating in a second configuration.

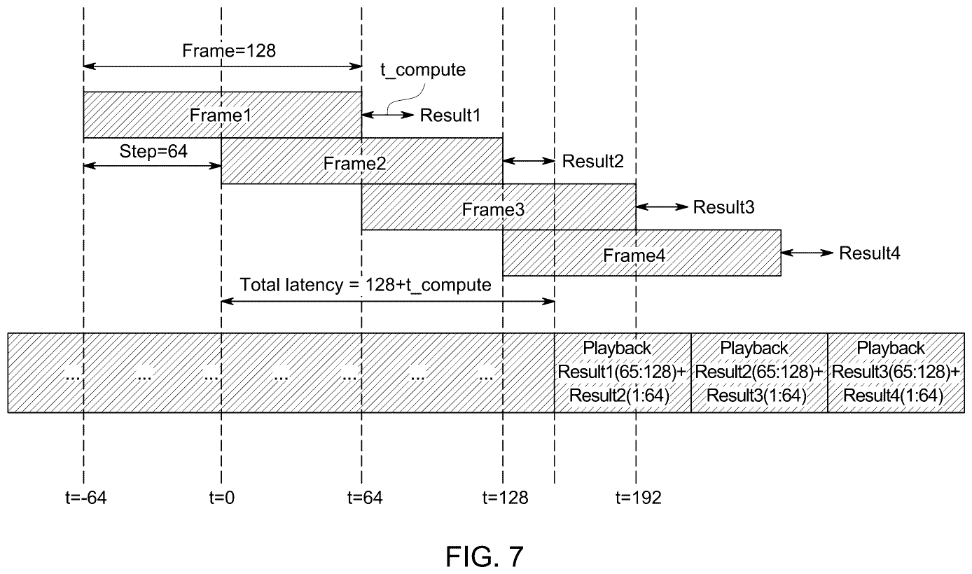

In some embodiments, the STFT circuitry 334 of FIG. 3 may be configured to generate overlapping frames (i.e., groups of consecutive samples) of frequency-domain input data. FIG. 7 illustrates processing of overlapping frames of data, in accordance with certain embodiments described herein. Overlapping frames of data (e.g., generated by the STFT circuitry 334) may have a particular frame size (i.e., how many samples each frame contains) and a particular step size (i.e., how many samples elapse from the start of one frame to the start of the next frame. (It should be appreciated that in some embodiments, overlapping frames of time-domain data may be used.) In the example of FIG. 7, the frame size is 128 samples and the step size is 64 samples. The frequency-domain processing circuitry 338 may be configured to process each frame of data and generate a result for that frame. FIG. 7 illustrates that Result1 results from processing Frame1, Result2 results from processing Frame2, etc. FIG. 7 further illustrates that processing each frame of data requires a time t_compute, namely, the time required for the frequency-domain processing circuitry 338 to process each frame of data. The iSTFT circuitry 336 may be configured to perform an inverse short-time Fourier transform on the result to convert it from the frequency domain to the time domain. The iSTFT circuitry 336 may be further configured to store results (e.g., Result1, Result2, etc.) in memory (either internal to the iSTFT circuitry 336 or external). The iSTFT circuitry 336 may be further configured to synthesize a single output from multiple results. Consider the time segment from t=0 samples to t=64 samples. That time segment is covered by the last 64 samples of Frame 1 and the first 64 samples of Frame2. A more accurate output for this time segment may be achieved by combining the last 64 samples of Result 1 and the first 64 samples of Result 2. (Such an operation may be considered a synthesis operation, an overlap-add operation, and/or an addition operation using time-shifting.) Thus, the iSTFT circuitry 336 may be configured to wait until Result2 has been generated before retrieving Result 1 and Result2 from memory and generating an output based on combining the last 64 samples of Result1 and the first 64 samples of Result2. In some embodiments, the iSTFT circuitry 342 may be configured to combine the last 64 samples of Result1 and the first 64 samples of Result2 by averaging the last 64 samples of Result1 and the first 64 samples of Result2. This combined output may then be transmitted to the time-domain processing circuitry 332 for further time-domain processing, and then to the receiver 106 for playback. Thus, in the example of FIG. 7, output data is generated based on processing two frames. It should be appreciated that in the example of FIG. 7, the total latency, which may be considered the time from input audio data is captured to the time when output audio data corresponding to that input audio data is played back, may be approximately equal to the time corresponding to 128 samples plus t_compute. (This may assume that the latency in performing the iSTFT and final time-domain processing is negligible, or this latency may be subsumed into t_compute).

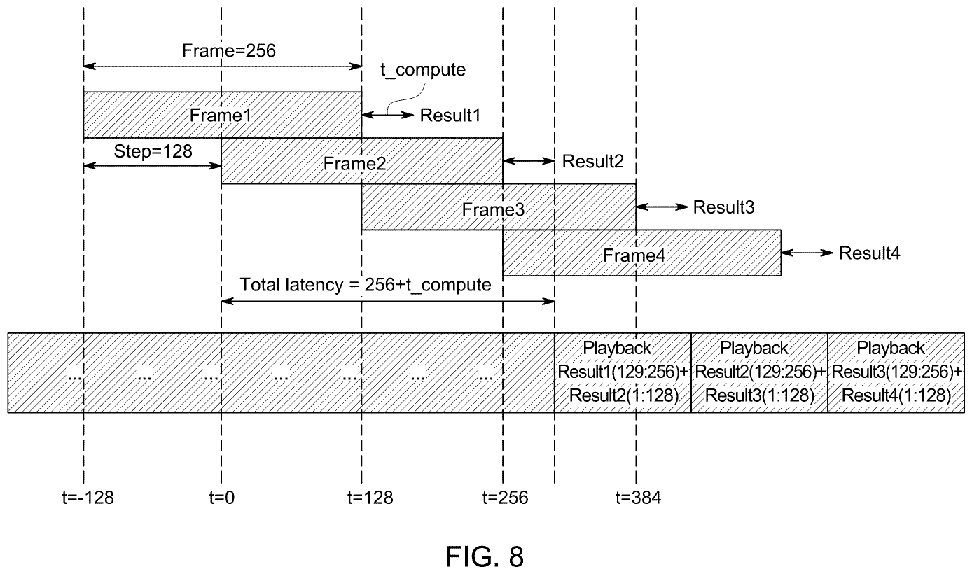

FIG. 8 illustrates processing of overlapping frames of data, in accordance with certain embodiments described herein. FIG. 8 differs from FIG. 7 in that in the example of FIG. 8, the frame size is 256 samples, the step size is 128 samples, and output data is generated based on processing two frames. As illustrated in FIG. 8, a given time segment is covered by two different frames. In the example of FIG. 8, the latency may be approximately equal to the time corresponding to 256 samples plus t_compute.

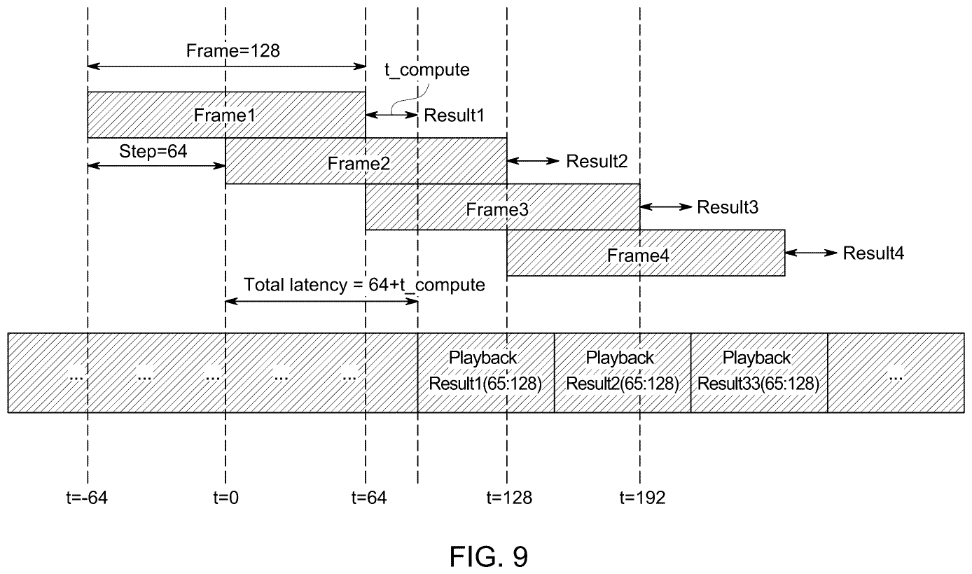

FIG. 9 illustrates processing of overlapping frames of data, in accordance with certain embodiments described herein. FIG. 9 differs from FIG. 7 in that in the example of FIG. 9, output data is generated based on processing one frame. That is, even though the time segment from t=0 to t=64 segments is covered by two frames, rather than waiting for processing of Frame2 to complete before playback, output audio data corresponding to this time segment is based just on processing Frame1, and playback begins after processing of Frame1. In the example of FIG. 9, the latency may be approximately equal to the time corresponding to 64 samples plus t_compute.

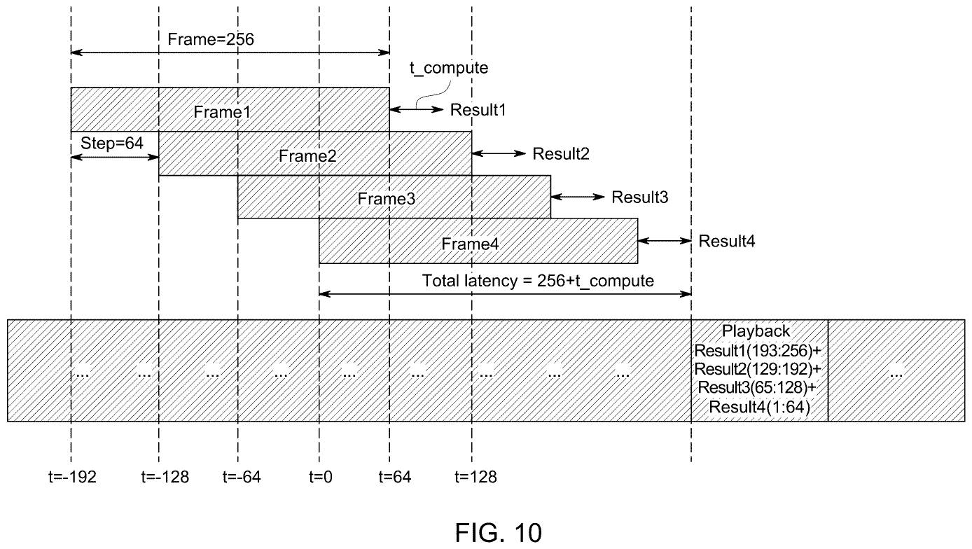

FIG. 10 illustrates processing of overlapping frames of data, in accordance with certain embodiments described herein. FIG. 10 differs from FIG. 7 in that in the example of FIG. 10, the frame size is 256 samples, the step size is 64 samples, and output data is generated based on processing four frames. As illustrated in FIG. 10, a given time segment is covered by four different frames. In the example of FIG. 10, the latency may be approximately equal to the time corresponding to 256 samples plus t_compute.

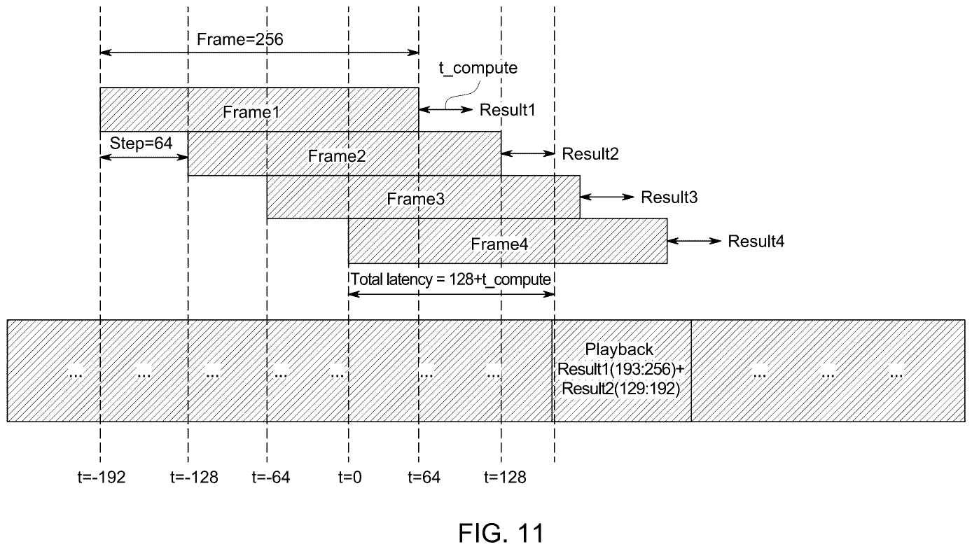

FIG. 11 illustrates processing of overlapping frames of data, in accordance with certain embodiments described herein. FIG. 11 differs from FIG. 7 in that in the example of FIG. 11, the frame size is 256 samples, the step size is 64 samples, and output data is generated based on processing two frames. In the example of FIG. 10, the latency may be approximately equal to the time corresponding to 128 samples plus t_compute. Further description of processing overlapping frames of data may be found in U.S. Pat. No. 12,231,851, entitled “Method, Apparatus, and System for Low Latency Audio Enhancement,” issued Feb. 18, 2025, which is incorporated by reference herein in its entirety.

Returning to FIG. 1, in some embodiments, the control circuitry 108 may be configured to control the processing circuitry 104 to operate using a first configuration or a second configuration, where the first configuration and second configuration have different data processing latencies (where latency may refer to the time between receiving input audio data and playing back output audio data based on that input audio data). As described above, the processing circuitry 104 may generally be configured to capture overlapping frames of input data using a frame size and a step size, generate neural network-based results from the overlapping frames of input data, and combine a number of the neural network-based results (where combining results may include combining whole results or partial results, e.g., combining the last 64 samples of Result1 and the first 64 samples of Result2 as described above) to generate each frame of output data. Latency may be modulated by modulating parameters such as frame size and/or the number of neural network-based results used to generate output data. For example, FIGS. 7 and 8 may illustrate how changing frame size may change latency. FIGS. 7 and 9 may illustrate how changing the number of results used to generate output data may change latency.

In some embodiments, combining neural network-based results may include combining portions of neural network-based results. In some embodiments, combining portions of neural network-based results may include adding portions of the neural network-based results. In some embodiments, adding portions of neural network-based results may include using time-shifting. In some embodiments, combining neural network-based results may include performing one or more overlap-add operations. As an example of the above, the combination may include adding the last 64 samples of Result 1 and the first 64 samples of Result2, where Result1 and Result2 may be longer than 64 samples. Thus, the combination may include adding portions of results (e.g., just 64 samples of each result and not the whole result). Such combination may also be considered time-shifting and/or overlap-addition, as the last samples of Result1 and the first samples of Result2 may be added, which may involve time-shifting and/or overlapping. In some embodiments, generating neural network-based results from overlapping frames of input data may include generating one neural network-based result from each of the overlapping frames of input data (e.g., one mask from each frame of input data). In some embodiments, the neural network-based results may be audio signals generated using neural network-generated masks. In some embodiments, the output data may be enhanced audio signals (i.e., audio signals generated by adding audio signals together).

In some embodiments, the control circuitry 108 may be configured to control the processing circuitry 104 to use a first combination of frame size, step size, and number of results when operating in the first configuration and to use a second combination of frame size, step size, and number of results when operating in the second configuration. The first data processing latency (i.e., the latency of the first configuration) may be based, at least in part, on the first combination of frame size, step size, and number of results, and the second data processing latency (i.e., the latency of the second configuration) may be used, at least in part, on the second combination of frame size, step size, and number of results. While changing step size without changing frame size or number of results might not change latency, changing step size may allow for changing another parameter, such as number of results or frame size, that does affect latency. Thus, in some embodiments, the control circuitry 108 may be configured to control the processing circuitry 104 to use a first frame size in the first configuration and a second frame size in the second configuration. In some embodiments, the control circuitry 108 may be configured to control the processing circuitry 104 to use a first step size in the first configuration and a second step size in the second configuration. In some embodiments, the control circuitry 108 may be configured to control the processing circuitry 104 to use a first number of results for generating output data in the first configuration and a second number of results for generating output data in the second configuration. Consider that the second configuration has a longer latency than the first configuration. In some embodiments, the first combination may have a shorter frame than the second combination. In some embodiments, the first combination may use a smaller number of results to generate output data than the second combination.

Consider that the first configuration has a first data processing latency and the second configuration has a second data processing latency longer than the first data processing latency. In some embodiments, the first data processing latency may be equal to 4 milliseconds, equal to 10 milliseconds, or between 4 and 10 milliseconds. In some embodiments, the first data processing latency may be equal to 4 milliseconds, equal to 9 milliseconds, or between 4 and 9 milliseconds. In some embodiments, the first data processing latency may be equal to 4 milliseconds, equal to 8 milliseconds, or between 4 and 8 milliseconds. In some embodiments, the second data processing latency may be equal to 10 milliseconds, equal to 16 milliseconds, or between 10 and 16 milliseconds. In some embodiments, the second data processing latency may be equal to 10 milliseconds, equal to 15 milliseconds, or between 10 and 15 milliseconds. In some embodiments, the second data processing latency may be equal to 10 milliseconds, equal to 14 milliseconds, or between 10 and 14 milliseconds.

In some embodiments, the frame size for the first configuration may be equal to 64 samples, equal to 192 samples, or between 64 samples and 192 samples. In some embodiments, the frame size for the second configuration may be equal to 192 samples, equal to 320 samples, or between 192 samples and 320 samples.

In some embodiments, the number of results for the first configuration may be 1, 2, or 3. In some embodiments, the number of results for the first configuration may be 1, 2, 3, or 4. In some embodiments, the number of results for the second configuration may be 3, 4, 5, or 6. In some embodiments, the number of results for the second configuration may be 5, 6, 7, or 8.

Generally, the specific values chosen for parameters such as frame size and number of results may be based on trading off latency for model output quality. In particular, larger values for frame size and number of results may result in better model output quality, but may also result in longer latencies; latencies that are too long may become intolerable for the wearer.

Additionally, when configuring the processing circuitry 104 to operate using the first configuration, the control circuitry 108 may be configured to control the neural network circuitry 114 to implement the one or more neural network layers 116, and when configuring the processing circuitry 104 to operate using the second configuration, the control circuitry 108 may be configured to control the neural network circuitry 114 to implement the one or more neural network layers 118. In some embodiments, the one or more neural network layers 116 and the one or more neural network layers 118 may have different weights. In some embodiments, the one or more neural network layers 116 and the one or more neural network layers 118 may have different topologies. For example, in embodiments in which the first configuration and the second configuration use different frame sizes, the one or more neural network layers 116 and the one or more neural network layers 118 may have initial layers with different input sizes based, at least in part, on the different frame sizes. For example, if the first configuration uses a first frame size and the second configuration uses a second frame size, then the one or more neural network layers 116 may have a first input size for their initial layer based, at least in part, on the first frame size, and the one or more neural network layers 118 may have a second input size for their initial layer based, at least in part, on the second frame size. As a specific example, if the first configuration uses a frame size of 128 and the second configuration uses a frame size of 256, then the input size of the initial layer of the one or more neural network layers 116 may have a size of 128 while the input size of the initial layer of the one or more neural network layers 118 may have a size of 256. In embodiments in which the first configuration and the second configuration use different frame sizes, the one or more neural network layers 116 and the one or more neural network layers 118 may have final layers with different output sizes based, at least in part, on the different frame sizes. For example, if the first configuration uses a first frame size and the second configuration uses a second frame size, then the one or more neural network layers 116 may have a first output size for their final layer based, at least in part, on the first frame size, and the one or more neural network layers 118 may have a second output size for their final layer based, at least in part, on the second frame size. As a specific example, if the first configuration uses a frame size of 128 and the second configuration uses a frame size of 256, then the output size of the final layer of the one or more neural network layers 116 may have a size of 128 while the output size of the final layer of the one or more neural network layers 118 may have a size of 256.

As described above, the input size of an initial layer of a neural network may be based, at least in part, on the frame size. In some embodiments, the input size may be based on more than one factor. For example, in some embodiments, the input size of an initial layer may be based both on the frame size and how many different beam patterns (i.e., audio signals with different beamformed directional patterns, as described above) are input to the neural network at once time. For example, if a first neural network has a frame size that is twice as big as the frame size of a second neural network, and the first neural network receives 3 times as many beam patterns as the second neural network, then the input size of the initial layer of the first neural network may be 6 times larger than the input size of the initial layer of the second neural network.

In embodiments in which the first configuration and the second configuration use the same frame sizes, the one or more neural network layers 116 and the one or more neural network layers 118 may have the same topology. The one or more neural network layers 116 and the one or more neural network layers 118 may be trained on training data using the particular frame size, step size, and number of results used to generate output data corresponding to their respective configurations. Thus, if the first configuration uses a frame size of 128 and the second configuration uses a frame size of 256, then the one or more neural network layers 116 may be trained using training data having frame size of 128 and the one or more neural network layers 118 may be trained using training data having frame size of 256.

In some cases, it may be more practical for the processing circuitry 104 to use the same frame size and the same step size when operating in the first and second configurations. Thus, in some embodiments, the processing circuitry 104 may be configured to use the same frame size and the same step size when operating in the first and second configurations. However, the two configurations may combine a different number of results to generate an output. When the first configuration and the second configuration use the same frame size and step size but combine a different number of results to generate an output, the two configurations may be configured to share at least one stage of data processing performed by the processing circuitry 104. For example, the shared stages may include performing the STFT, certain pre-processing steps (i.e., upstream of the neural network), and certain post-processing steps (i.e., downstream of the neural network). In other words, the processing circuitry 104 might not need to do these stages of the data processing separately when operating in each configuration. Such pre-processing and post-processing steps may be performed by the time-domain processing circuitry 332 and/or the frequency-domain processing circuitry 338.

In addition to sharing the STFT and certain pre-and post-processing steps, in some embodiments, even the one or more neural network layers 116 and the one or more neural network layers 118 for the first and second configurations, respectively, may be the same (at least in part), and just the iSTFT may be different, as the iSTFT for each configuration would combine a different number of results to generate an output. Generally, the one or more neural network layers 116 and the one or more neural network layers 118 for the first and second configurations, respectively, might not share any layers, or they may share some layers, or they may share all layers. In some embodiments, each configuration may be configured to use a neural network having the same backbone but with two heads coming off the shared backbone, one head optimized for an iSTFT combining one number of results and another head optimized for an iSTFT combining another number of results. In other words, the one or more neural network layers 116 used by the first configuration may include one or more shared layers and one or more first non-shared layers, and the one or more neural network layers 118 used by the second configuration may include the one or more shared layers and one or second non-shared layers. The processing circuitry 104 may be configured to generate output data from a first number of results when operating in the first configuration and to generate output data from a second number of results when operating the second configuration. The one or more first non-shared layers may be trained based on the first number of results, and the one or more second non-shared layers may be trained based on the second number of results.

In terms of optimizing neural network layers based on a particular number of results, in some embodiments, output training data may include both masks in addition to enhanced audio signals generated from mask application and combination of the particular number of results together. In other words, the losses used for training the neural network layers may include both losses corresponding to the masks as well as losses corresponding to the outputs after combination of the particular number of results together. In this manner, the neural network layers may be optimized based on the particular number of results used to generate output data.

In some embodiments, the control circuitry 108 may be configured to control the processing circuitry 104 to operate using the first configuration or the second configuration based on user activation of the user input device 128. For example, activation of the user input device 128 may cause the control circuitry 108 to toggle between the first configuration and the second configuration.

In some embodiments, the communication circuitry 110 may be configured to receive an indication from the processing device 220, and the control circuitry 108 may be configured to control the processing circuitry 104 to operate using the first configuration or the second configuration based on the indication received from the processing device 220. In some embodiments, the processing device 220 may be configured to generate the indication based on a user selection from a graphical user interface (GUI) displayed by the processing device 220. For example, activation of an option on the graphical user interface (GUI) displayed by the processing device 220 may cause the communication circuitry 222 of the processing device 220 to transmit an indication to the communication circuitry 110. The indication received from the processing device 220 by the communication circuitry 110 may cause the control circuitry 108 to toggle between the first configuration and the second configuration. Alternatively, activation of a first option on a GUI displayed by the processing device 220 may cause the communication circuitry 222 of the processing device 220 to transmit a first indication to the communication circuitry 110 and activation of a second option on the GUI may cause the communication circuitry 222 of the processing device 220 to transmit a second indication to the communication circuitry 110. Receiving the first indication from the processing device 220 may cause the control circuitry 108 to select the first configuration, and receiving the second indication from the processing device 220 may cause the control circuitry 108 to select the second configuration.

When the control circuitry 108 is configured to control the processing circuitry 104 to operate using the first configuration or the second configuration based on a user activation of the user input device 128 or based on an indication received from the processing device 220, this may be considered user-controlled mode switching. In other words, the first configuration may be considered a first mode, the second configuration may be considered a second mode, and the user may be able to switch from the first mode to the second mode using the user input device 128 and/or the processing device.

In some embodiments, the control circuitry 108 may be configured to control the processing circuitry 104 to operate using the first configuration or the second configuration based on a determination performed by the monitoring circuitry 130. The control using the monitoring circuitry 130 may be considered dynamic adjustment of the latency, as the latency (associated with the configuration) may dynamically change based on the determination performed by the monitoring circuitry 130. In some embodiments, the determination may be a measurement of ambient volume in the environment. In some embodiments, the control circuitry 108 may be configured to control the processing circuitry 104 to switch between operating using the first configuration and operating using the second configuration when the ambient volume crosses a threshold. In some embodiments, the first configuration may have a lower data processing latency than the second configuration, and the control circuitry 108 may be configured to control the processing circuitry 104 to switch from operating using the first configuration to operating using the second configuration when the ambient volume rises above a threshold. In some embodiments, the determination may be a measurement of SNR of the environment. In some embodiments, the control circuitry 108 may be configured to control the processing circuitry 104 to switch between operating using the first configuration and operating using the second configuration when the SNR crosses a threshold. In some embodiments, the first configuration may have a lower data processing latency than the second configuration, and the control circuitry 108 may be configured to control the processing circuitry 104 to switch from operating using the first configuration to operating using the second configuration when the SNR falls below a threshold.

In some embodiments, the determination performed by the monitoring circuitry 130 may be a determination of a presence of an own-voice signal or a level of the own-voice signal. Generally, in some embodiments the control circuitry 108 may be configured to control the processing circuitry 104 to switch between operating using the second configuration to operating using the first configuration based on own-voice detection. In some embodiments, the first data processing latency may be shorter than the second data processing latency, and the control circuitry may be configured to control the processing circuitry to switch from operating using the second configuration to operating using the first configuration when the own-voice signal is detected, or when the level of the own-voice signal exceeds a threshold. Following is a non-limiting list of techniques for own-voice detection: 1. A neural network trained to detect when the wearer of the ear-worn device 100 is speaking, 2. A neural network trained to detect voice signatures and use the voice signatures to specifically output the wearer's own voice. Further description of voice signatures may be found in U.S. Pat. No. 11,812,225 (referenced above) and U.S. Pat. No. 12,418,756, titled “System and method for enhancing speech of target speaker from audio signal in an ear-worn device using voice signatures,” and issued Sep. 16, 2025, 3. Traditional beamforming techniques to isolate near-field voices coming from in front of the wearer, 4. Bone conduction microphones on the receiver 106 of the ear-worn device 100, 5. A sensor on the ear-worn device 100 configured to detect the vibration created by talking, 6. SNR estimation, in which own-voice is considered detected whenever any voice signal is over a certain threshold. In some embodiments, when estimating SNR, the ear-worn device 100 may be configured to take a fast-moving average of the speech portion of the audio stream and a slow-moving average of the noise portion of the audio stream to compute the SNR. This may enable the SNR to rise quickly when someone starts speaking, and enable the SNR to not drop during an impulse noise 6. A combination of the above.

When the control circuitry 108 is configured to control the processing circuitry 104 to operate using the first configuration or the second configuration based on a measurement performed by the monitoring circuitry 130, this may be considered automatic control of configuration. In some embodiments, the control circuitry 108 might only be configured to perform automatic control of configuration when a particular mode (which may be referred to as a first mode) has been selected by the user. When a user has not made such a selection, the control circuitry 108 may be configured to operate in a second mode, in which automatic control of configuration selection is not performed. Selection of the first mode or the second mode by the user may be performed using the user input device 128 and/or using the processing device 220.

The above description has described how the control circuitry 108 may be configured to control the processing circuitry 104 to operate using the first configuration or the second configuration based on activation of the user input device 128, based on receiving an indication from the communication circuitry 110, or based on a determination performed by the monitoring circuitry 130. In some embodiments, the control circuitry 108 may be configured to control the processing circuitry 104 to operate using the first configuration or the second configuration just based on activation of the user input device 128. In some embodiments, the control circuitry 108 may be configured to control the processing circuitry 104 to operate using the first configuration or the second configuration just based on receiving an indication from the communication circuitry 110. In some embodiments, the control circuitry 108 may be configured to control the processing circuitry 104 to operate using the first configuration or the second configuration just based on a determination performed by the monitoring circuitry 130. In some embodiments, the control circuitry 108 may be configured to control the processing circuitry 104 to operate using the first configuration or the second configuration just based on activation of the user input device 128 or based on a determination performed by the monitoring circuitry 130. In some embodiments, the control circuitry 108 may be configured to control the processing circuitry 104 to operate using the first configuration or the second configuration just based on activation of the user input device 128 or based on receiving an indication from the communication circuitry 110. In some embodiments, the control circuitry 108 may be configured to control the processing circuitry 104 to operate using the first configuration or the second configuration just based on receiving an indication from the communication circuitry 110 or based on a determination performed by the monitoring circuitry 130. Thus, in some embodiments, some combination of the monitoring circuitry 130, the user input device 128, and the communication circuitry 110 may be absent, or not configured for use with switching between the first and second configuration as described herein.

While the above description has described embodiments using just two different latencies, one for a first configuration and one for a second configuration, in some embodiments, the control circuitry 108 may be configured to control the processing circuitry 104 to operate using different latencies at different times, and there may be more than two latencies used, or there may be a continuous range of latencies used. Thus, in some embodiments, the control circuitry 108 may be configured to control the processing circuitry 104 to vary frame size, step size, and/or the number of results used to generate output data over more than two combinations. In some embodiments, the specific latency used may be based, for example, on the environment (e.g., ambient volume or SNR). For example, in some embodiments, if the ambient volume is within a first range, the processing circuitry 104 may be configured to use one result to generate output data. If the ambient volume is within a second range, the processing circuitry 104 may be configured to use two results to generate output data. If the ambient volume is within a third range, the processing circuitry 104 may be configured to use three results to generate output data. If the ambient volume is within a fourth range, the processing circuitry 104 may be configured to use four results to generate output data. While this example describes four ranges, a different number may be used as well. In such embodiments, the neural network circuitry 114 may be configured to implement the same one or more neural network layers regardless of the latency selected. Thus, the neural network circuitry 114 might be configured only to implement one set of neural network layers (e.g., the one or more neural network layers 116) rather than two sets. In some embodiments, the one or more neural network layers may have multiple heads, each trained to use a different number of results to generate output data. Generally, in some embodiments, the one or more neural network layers may include at least a first head and a second head, where the first head is trained for the first configuration and the second head is trained for the second configuration. However, in some embodiments, the one or more neural network layers might include just one head trained for both configurations.

In some embodiments, the control circuitry 108 may be configured to control the processing circuitry 104 to operate using a third configuration, in which no neural network-based processing is performed.

While the above description has described audio enhancement performed in the frequency domain, in some embodiments audio enhancement may be performed in the time domain, in which case STFT and iSTFT might not be performed.

It should be appreciated from the above that the control circuitry 108 may be configured, when controlling the processing circuitry 104 to operate using the first configuration or the second configuration, to control the processing circuitry 104 to switch from operating using the first configuration to operating using the second configuration, or from operating using the second configuration to operating using the first configuration. Switching from a configuration using one neural network (i.e., the one or more neural network layers 116) to a configuration using another neural network (i.e., the one or more neural network layers 118) could introduce audible artifacts when the switch occurs. Following will be a description of methods for switching between two configurations using different neural networks (or generally, different sets of neural network layers), in manners that may reduce audible artifacts associated with the transition.

The following description will refer to a path through the processing circuitry 104 illustrated in FIG. 3, using parameters (e.g., frame size, number of results combined to generate an output) and a neural network specific to a particular configuration, as a pipeline. Thus, the processing circuitry 104 may be configured to use a first pipeline (a.k. a, pipeline A) when operating using the first configuration and to use a second pipeline (a.k. a, pipeline B) when operating using the second configuration. The following description will assume a switch from a configuration using pipeline A to a configuration using pipeline B.

### Method 1

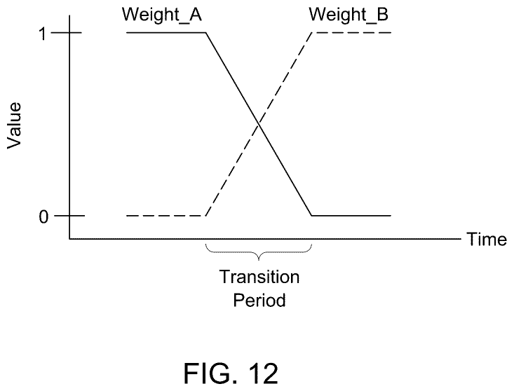

In some embodiments, pipeline A and pipeline B may be configured to run simultaneously during a transition period when the processing circuitry 104 switches from operating using the first configuration to operating using the second configuration. As referred to herein, two pipelines running simultaneously should be understood to mean that when input data is received, each pipeline is run on that same input data and their outputs are combined in some manner. In some embodiments, pipeline A and pipeline B may be run on the same input data at the same time or approximately the same time (a.k.a., in parallel). In some embodiments, pipeline A and pipeline B may be run on the same input data one after another (a.k.a., in series). In either type of embodiment, pipeline A and pipeline B may each be configured to generate outputs for the same input data. In some embodiments, the processing circuitry 104 may be configured to combine an output from pipeline A and an output from pipeline B. (It should be appreciated that the output from each pipeline may result from combination of results, e.g., through overlap-add operations, as described above, that are different from the combination operations described below.) In some embodiments, the processing circuitry 104 may be configured, when combining the output from pipeline A and the output from pipeline B, to use a first weight for the output from pipeline A and a second weight for the output from pipeline B. The first weight and the second weight may be different during at least one time in the transition period, and the first weight and the second weight may change during the transition period. For a switch from a configuration using pipeline A to a configuration using pipeline B, the first weight may transition from high to low (or in other words, decrease) and the second weight may transition from low to high (or in other words, increase) during the transition period. Let the combined output be weight_A*Output_A+weight_B*Output_B, where Output_A is the output of Pipeline A, Output_B is the output of Pipeline B, weight_A is the weight applied to Output_A, and weight_B is the weight applied to Output_B. In some embodiments, weight_A may transition from 1 to 0 while weight_B may transition within the same transition period from 0 to 1. The transition time period may last, for example, for a time period corresponding to 2, 3, 4, 5, 6, 7, 8, 9, or 10 frames. Such a transition may help to avoid audible artifacts in switching between two different pipelines, although it may be more computationally expensive to run both pipelines on the same input data. FIG. 12 illustrates an example of how the values of weight_A and weight_B may transition over time during a transition period, in accordance with certain embodiments described herein.

### Method 2

In some embodiments, pipeline A and pipeline B might not be run simultaneously. In such embodiments, the control circuitry 108 may be configured to detect a period when there is no speech, and control the processing circuitry 104 to switch from operating using the first configuration to operating using the second configuration during a transition period, such that the transition period is during, or at least starts during, the period when there is no speech. In other words, when controlling the processing circuitry 104 to switch from one configuration to another, the control circuitry 108 may be configured to wait until there is no speech before proceeding with the switch. As described above, the audio enhancement circuitry 112 may be configured to use the neural network circuitry 114 to generate a speech component of an input audio signal. In some embodiments, the control circuitry 108 may be configured to determine when there is no speech based on the speech component of the input audio signals (e.g., based on their volume or amplitude) generated using the neural network circuitry 114. In some embodiments, the control circuitry 108 may be configured to determine when there is no speech using a stationary noise estimate generated by the SNS circuitry 462. In such embodiments, the control circuitry 108 may be configured to determine whether the audio signal 454a is similar to or within a threshold of the stationary noise estimate generated by the SNS circuitry 462; if so, the control circuitry 108 may be configured to determine that there is no speech. In some embodiments, during a period of no speech, the processing circuitry 104 may generally be configured to implement the transition period from pipeline A to pipeline B by transitioning from outputting the output of pipeline A to outputting an attenuated version of the input audio signal (e.g., the audio signal 454a), to outputting the output of pipeline B. In other words, the processing circuitry 104 may be configured to combine the output of pipeline A and an attenuated version of an audio signal received by the neural network circuitry 114 during a first portion of the transition period, and combine the attenuated version of the audio signal and the output from pipeline B during a second portion of the transition period subsequent to the first portion. Further detail regarding the attenuated version of the audio signal, such as by what factor it may be attenuated, may be found below.

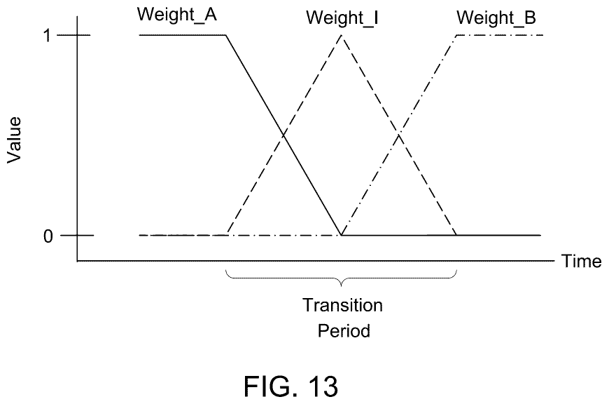

In more detail, in some embodiments, the processing circuitry 104 may be configured when combining the output of pipeline A and the attenuated version of the input audio signal, to use a first weight for the output of pipeline A and a second weight for the attenuated version of the input audio signal. The first weight and the second weight may be different during at least one time in the first portion of the transition period, and the first weight and the second weight may change during the first portion of the transition period. The first weight may transition from high to low (or in other words, decrease) and the second weight may transition from low to high (or in other words, increase) during the first portion of the transition period. For example, when the noise gain application circuitry 452 is configured to generate speech+weight_noise*noise, as described with reference to FIG. 4, the input audio signal here may be attenuated by weight_noise (i.e., the value for weight_noise used by the noise gain application circuitry 452 for the mixing). As another example, the processing circuitry 104 may be configured to empirically determine the attenuation factor by measuring the volume of the signal after the mixing as X, measuring the volume of the input signal as Y, and using an attenuation factor of X/Y. Let the combined output be weight_A*Output_A+weight_I*weight_noise*Input, where Output_A is the output of Pipeline A, Input is the input audio signal (e.g., the audio signal 454a), weight_A is the weight applied to Output_A, and weight_I is the weight applied to the attenuated version of Input. In some embodiments, weight_A may transition from 1 to 0 while weight_I may transition within the same time period from 0 to 1. Subsequently, the processing circuitry 104 may be configured, when combining the attenuated version of the input audio signal and the output from pipeline B, to use a first weight for the attenuated version of the input audio signal and a second weight for the output of pipeline B. The first weight and the second weight may be different during at least one time in the second portion of the transition period, and the first weight and the second weight change during the second portion of the transition period. The first weight may transition from high to low (or in other words, decrease) and the second weight may transition from low to high (or in other words, increase) during the second portion of the transition period. Let the combined output be weight_B*Output_B+weight_I*weight_noise*Input, where Output_B is the output of Pipeline B, Input is the input audio signal (e.g., the audio signal 454a), weight_B is the weight applied to Output_B, and weight_I is the weight applied to Input. In some embodiments, weight_B may transition from 0 to 1 while weight_I may transition within the same time period from 1 to 0. FIG. 13 illustrates an example of how the values of weight_A and weight_B may transition over time during a transition period, in accordance with certain embodiments described herein. Such a transition may help to avoid audible artifacts in switching between two different pipelines, without running both pipelines on the same input data, which may be more computationally expensive. The transition from Output_A to weight_noise*Input and from weight_noise*Input to Output_B may have reduced noticeability during a period of no speech. Because the audio enhancement circuitry 112 may be configured to output speech+weight_noise*noise, when there is no speech, Output_A and Output_B may be weight_noise*noise, and Input may be noise such that weight_noise*Input is weight_noise*noise as well. In some embodiments, when there is a period of no speech, the output of pipeline A may transition directly to the output of pipeline B using the methods described below.

### Method 3

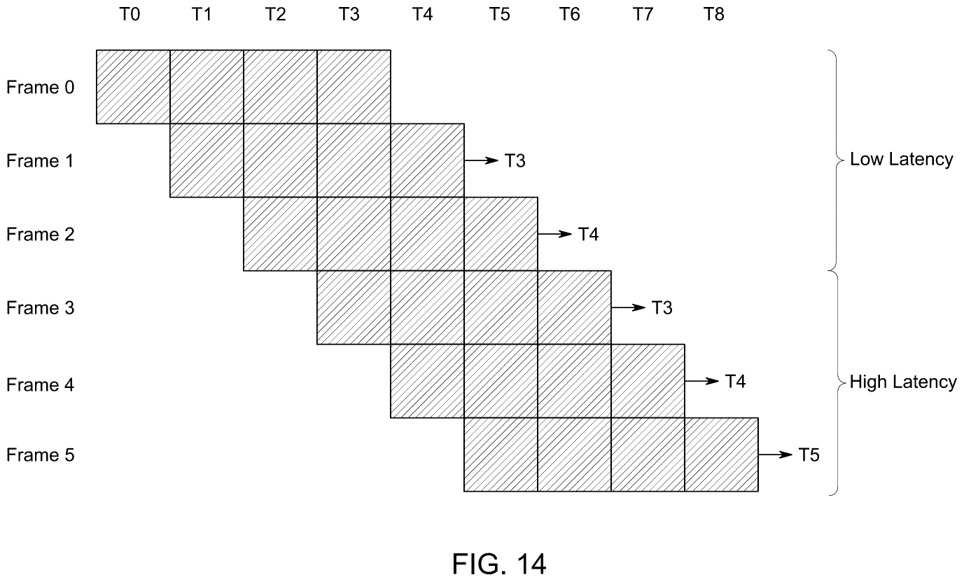

In some embodiments, pipeline A and pipeline B might not be run simultaneously and the control circuitry 108 might not be configured to perform switches based on when there is no speech. Following will be a description of switching from pipeline A to pipeline B, when pipeline A has a lower latency than pipeline B. FIG. 14 illustrates an example of processing overlapping frames of data, in accordance with certain embodiments described herein. Consider that pipeline A (lower latency) combines two results to generate an output and pipeline B (higher latency) combines four results to generate an output. Consider that the first frame processed with pipeline B is frame 3. After Frame 1 is processed, the next output generated may correspond to time segment T3, because Frame 1 is the second frame to cover T3, and Frame 1 is processed using the low latency pipeline which combines two results to generate an output. After Frame 2 is processed, the next output generated may correspond to time segment T4, because Frame 2 is the second frame to cover T4, and Frame 2 is processed using the low latency pipeline which combines two results to generate an output. After Frame 3 is processed, the next output generated may correspond to time segment T3, because Frame 3 is the fourth frame to cover T3, and Frame 3 is processed using the high latency pipeline which combines four results to generate an output. After Frame 4 is processed, the next output generated may correspond to time segment T4, because Frame 4 is the fourth frame to cover T4, and Frame 4 is processed using the high latency pipeline which combines four results to generate an output. After Frame 5 is processed, the next output generated may correspond to time segment T5, because Frame 5 is the fourth frame to cover T5, and Frame 5 is processed using the high latency pipeline which combines four results to generate an output. Generally, then, when transitioning from a lower latency pipeline to a higher latency pipeline, the processing circuitry 104 may be configured to generate multiple outputs for at least one time segment. For example, in FIG. 14, an output is generated for time segments T3 and T4 twice. In some embodiments, instead of playing back the second outputs for T3 and T4 as they are, the second outputs for T3 and T4 may be combined (e.g., averaged) with the first outputs for T3 and T4, respectively, to smooth over the transition.

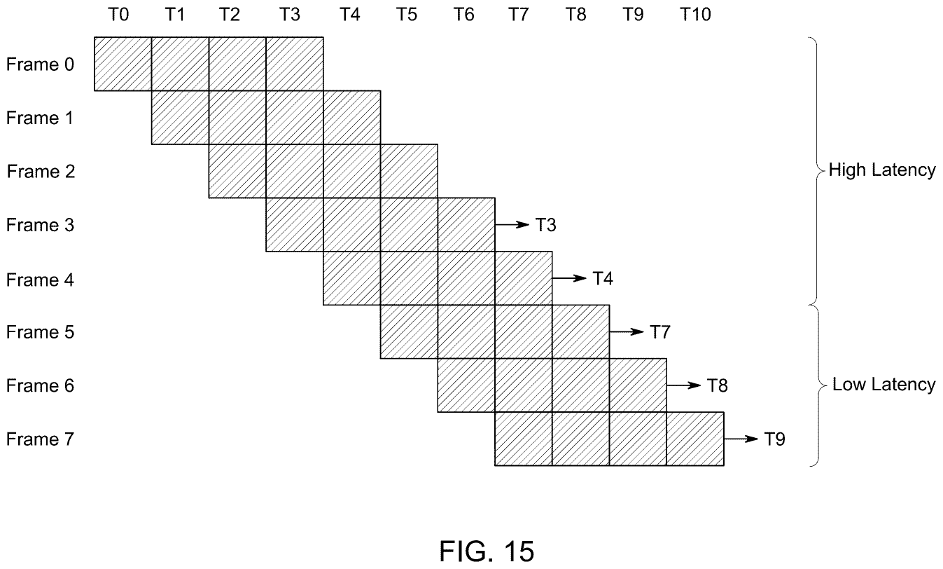

Following will be a description of switching from pipeline A to pipeline B, when pipeline A has a higher latency than pipeline B. FIG. 15 illustrates an example of processing overlapping frames of data, in accordance with certain embodiments described herein. Consider that pipeline A (higher latency) combines four results to generate an output and pipeline B (lower latency) combines two results to generate an output. Consider that the first frame processed with pipeline B is frame 5. After Frame 3 is processed, the next output generated may correspond to time segment T3, because Frame 3 is the fourth frame to cover T3, and Frame 1 is processed using the high latency pipeline which combines four results to generate an output. After Frame 4 is processed, the next output generated may correspond to time segment T4, because Frame 4 is the second frame to cover T4, and Frame 4 is processed using the high latency pipeline which combines four results to generate an output. After Frame 5 is processed, the next output generated may correspond to time segment T7, because Frame 5 is the second frame to cover T7, and Frame 5 is processed using the low latency pipeline which combines two results to generate an output. After Frame 6 is processed, the next output generated may correspond to time segment T8, because Frame 6 is the second frame to cover T8, and Frame 6 is processed using the low latency pipeline which combines two results to generate an output. After Frame 7 is processed, the next output generated may correspond to time segment T9, because Frame 7 is the second frame to cover T9, and Frame 7 is processed using the low latency pipeline which combines two results to generate an output. Generally, then, when transitioning from a higher latency pipeline to a lower latency pipeline, the processing circuitry 104 may be configured to skip generating outputs for at least one time segment. For example, in FIG. 15, no outputs are generated for time segments T5 and T6, or in other words, time segments T5 and T6 are skipped. In some embodiments, instead of playing back the output for T7 (i.e., the first output after the skip) as is, that output may be combined (e.g., averaged) with the output corresponding to T4 (i.e., the previous output output), to smooth over the transition.

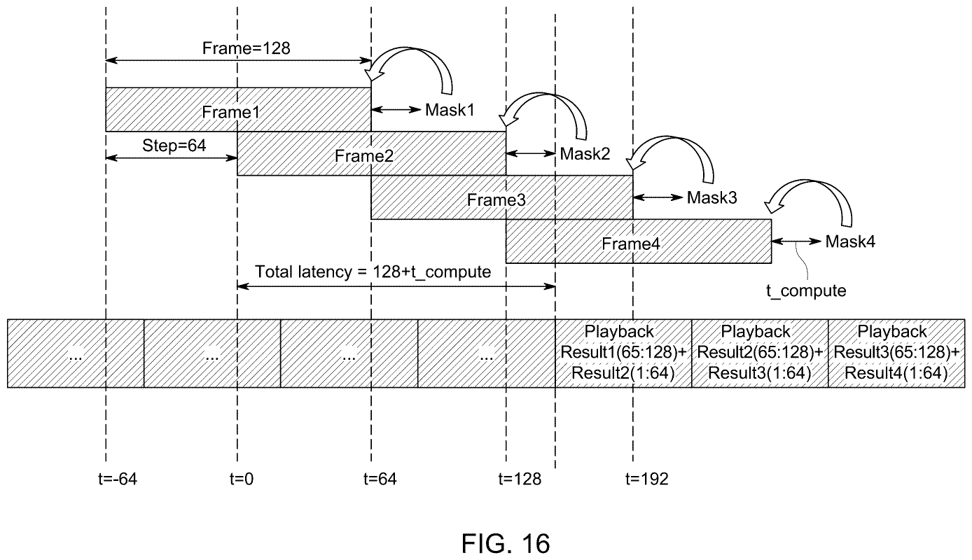

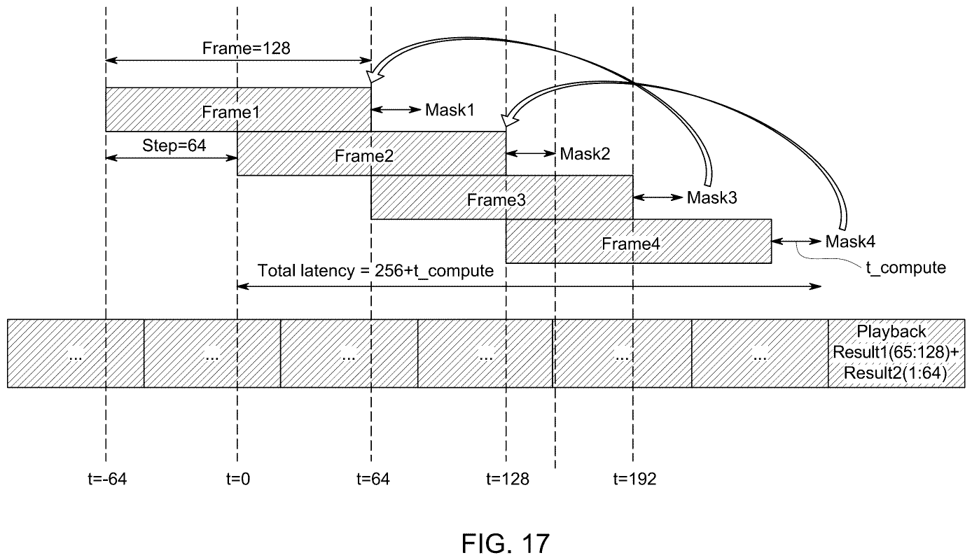

FIGS. 16-17 illustrates a method for switching latency, in accordance with certain embodiments described herein. FIG. 16 illustrates another perspective on FIG. 7; like in FIG. 7, in FIG. 16, the frame size is 128 samples, the step size is 64 samples, and output data is generated based on processing two frames (the same as in FIG. 7). In FIGS. 7-11, these figures generically refer to generating “Results.” In some embodiments, such results may be audio signals directly outputted by neural networks that receive audio signals as inputs. In some embodiments, the neural networks may output masks, and the results may be enhanced audio signals obtained by applying the masks to audio signals. FIG. 16 specifically illustrates that a mask, Mask 1, is generated by a neural network based on processing Frame 1, Mask 2 is generated by the neural network based on processing Frame 2, etc. The arrows illustrate that Mask 1 is applied to Frame 1 to generate Result 1, Mask 2 is applied to Frame 2 to generate Result 2, etc. The latency, like in FIG. 7, may be approximately equal to the time corresponding to 128 samples plus t_compute. As an example, it can be seen that this latency may be due to waiting until Mask 2 has been generated before playing back a result corresponding to the time segment between t=0 and t=64.

In FIG. 17, Mask 3 is applied to Frame 1 to generate Result 1, and Mask 4 is applied to Frame 2 to generate Result 2. The latency, like in FIG. 10, may be approximately equal to the time corresponding to 256 samples plus t_compute. As an example, it can be seen that this latency may be due to waiting until Mask 4 has been generated before playing back a result corresponding to the time segment between t=0 and t=64. As in FIG. 16, in FIG. 17, the frame size is 128 samples, the step size is 64 samples, and output data is generated based on processing two frames. However, as an example, it can be seen in FIG. 17 that the neural network is able to see all the data in Frames 1-4 before playing back a result corresponding to the time segment between t=0 and t=64, whereas in FIG. 16 the neural network just sees the data in Frames 1-2 before playing back a result corresponding to the time segment between t=0 and t=64. It should be appreciated that because the processing in FIG. 17 may allow the neural network to see more data after a time segment before outputting a result for that time segment, the processing of FIG. 17 may enable higher quality output, but with longer latency. It should also be appreciated that switching the latency (e.g., between the configuration of FIG. 16 and the configuration of FIG. 17) to enable higher quality output may be achieved without changing the frame size, step size, or how many frames are processed together to generate output data. This in turn may mean that the STFT and iSTFT operations might not need to change when switching latency.

It should be appreciated that in FIG. 17, a mask may be generated based on one frame and applied to another frame. In some embodiments, a stateful neural network (e.g., a recurrent neural network) may be trained to store information about previous frames, and thereby generate masks later than can meaningfully be applied to earlier frames. In some embodiments, instead of inputting, for example, just Frame 4 to the neural network in order to generate Mask 4 which is applied to Frame 2, Frames 2 and 4, or Frames 2-4, may be inputted to the neural network in order to generate Mask 4. In such embodiments, the multiple frames may be concatenated, or added together. It should be appreciated that while the embodiment of FIG. 17 illustrates a mask being applied to a frame that is three frames earlier, in other embodiments a mask may be applied to other previously-occurring frames. Generally, the approach to switching data processing latency illustrated by FIGS. 16-17 may be described as generating a mask by a neural network based on inputting at least Frame N to the neural network, and applying the mask to Frame N-M, where M≥0. Data processing latency may be changed by changing M. In FIG. 16, M=0, and in FIG. 17, M=2.

Training a neural network to process data as illustrated in FIGS. 16-17 may proceed as follows. Input data may include a stream of audio that is broken into frames. Output data including a noise-reduced or noise-reduced and spatially-focused version of each frame of the input data may be obtained. For each given frame N of input data that is provided to the neural network, a mask may be determined that, when applied to the frame of input data, results in the corresponding frame of output data. In some embodiments, a set of training data may then include a frame N as input training data and the mask for Frame N-M as output training data. For example, in FIG. 17, a set of training data may include Frame 4 and the mask for Frame 2. In some embodiments, a set of training data may include frames N and N-M as input training data and the mask for Frame N-M as output training data. For example, in FIG. 17, a set of training data may include Frames 4 and 2 and the mask for Frame 2. In some embodiments, a set of training data may include frames N-M through N as input training data and the mask for Frame N-M as output training data. For example, in FIG. 17, a set of training data may include Frames 2-4 and the mask for Frame 2. Thus, the neural network may learn to generate, based at least on receiving Frame N as input, a mask for applying to Frame N-M. M may be equal to or greater than zero. When M=0, the neural network may be trained to receive a frame, generate a mask based on that frame, and apply the mask to that same frame. When M>0, the neural network may be trained to receive a frame, generate a mask based on that frame, and apply the mask to a previous frame.

As described above, the control circuitry 108 may be configured to control the processing circuitry 104 to operate using a first configuration or a second configuration. In some embodiments, the first configuration may have a first data processing latency and the second configuration may have a second data processing latency different from the first data processing latency. As illustrated in FIGS. 16-17, the processing circuitry 104 may be configured to receive at least one frame N of data, generate a mask based on the at least one frame N of data using the neural network circuitry 114, and apply the mask to a frame N-M of data, where M is greater than or equal to zero. The processing circuitry 104 may be configured to use a first value for M when operating in the first configuration and a second value for M when operating in the second configuration. In some embodiments (e.g., as illustrated in FIG. 17), in at least one of the first configuration and the second configuration, the frame N-M of data is received before the frame N of data (i.e., M>0). In some embodiments (e.g., as illustrated in FIG. 16), in at least one of the first configuration and the second configuration, the frame N is the same frame as the frame N-M (i.e., M=0). In some embodiments, the first data processing latency is shorter than the second data processing latency, and the first value for M is less than the second value for M. For example, in FIG. 16, M=0, in FIG. 17, M=2, and the data processing latency in FIG. 16 is shorter than the data processing in FIG. 17. In some embodiments, when the processing circuitry 104 receives the at least one Frame N of data, it may be configured to receive Frame N and Frame N-M, and when the processing circuitry 104 generates the mask based at least on Frame N, it may be configured to generate the mask based on Frame N and Frame N-M. For example, in FIG. 17, Frame N may be Frame 4 and Frame N-M may be Frame 2. In some embodiments, when the processing circuitry 104 receives the at least one Frame N of data, it may be configured to receive Frame N through Frame N-M, and when the processing circuitry 104 generates the mask based at least on Frame N, it may be configured to generate the mask based on Frame N through Frame N-M. For example, in FIG. 17, Frame N through Frame N-M may include Frames 4, 3, and 2. When the processing circuitry 104 operates using the first configuration, the neural network circuitry 114 may be configured to implement the one or more neural network layers 116. When the processing circuitry 104 operates using the second configuration, the neural network circuitry 114 may be configured to implement the one or more neural network layers 118. The one or more neural network layers 116 and 118 may be trained to generate masks for applying to frames received different amounts of time ago, as described above. For example, the neural network layers used for the configuration of FIG. 16 may be trained to receive a Frame N and generate a mask for applying to Frame N. The neural network layers used for the configuration of FIG. 17 may be trained to receive a Frame N and generate a mask for applying to Frame N-2.

Deploying audio enhancement techniques may introduce delays between when a sound is emitted by the sound source and when the enhanced sound is output to a user. For example, such techniques may introduce a delay between when a speaker speaks and when a listener hears the enhanced speech. During in-person communication, long latencies can create the perception of an echo as both the original sound and the enhanced version of the sound are played back to the listener. Additionally, long latencies can interfere with how the listener processes incoming sound due to the disconnect between visual cues (e.g., moving lips) and the arrival of the associated sound. To attain tolerable latencies when implementing a neural network on an ear-worn device, the ear-worn device may need to be capable of performing billions of operations per second. To address power issues with such demanding requirements, neural network circuitry (e.g., any of the neural network circuitry described herein, in addition to other circuitry) may be implemented on a chip in the ear-worn device. Thus, in some embodiments, some or all of the processing circuitry (e.g., any of the processing circuitry described herein, including some or all of any of the audio enhancement circuitry described herein and/or some or all of any of the neural network circuitry described herein) may be implemented on a single same chip (i.e., a single semiconductor die or substrate) in the ear-worn device. Further description of chips incorporating (in some embodiments, among other elements) neural network circuitry for use in ear-worn devices may be found in U.S. Pat. No. 11,886,974, entitled “Neural Network Chip for Ear-Worn Device,” issued Jan. 30, 2024, which is incorporated by reference herein in its entirety, as well as below.

Any of the neutral network circuitry described herein (e.g., the neural network circuitry 114) may include circuitry configured to perform operations necessary for computing the output of a neural network layer. One such operation may be a matrix-vector multiplication. In some embodiments, neural network circuitry may include multiple identical tiles on the chip, each including multiple multiply-and-accumulate circuits configured to perform intermediate computations of a matrix-vector multiplication in parallel and then compute results of the intermediate computations into a final result. Each tile may additionally include memory configured to store neural network weights, registers configured to store input activation elements, and routing circuitry configured to facilitate communication of status and data between tiles. Other types of circuitry configured to perform processing described herein may be implemented as digital processing circuitry on the chip. In some embodiments, such digital processing circuitry may use a SIMD (single instruction multiple data) architecture. Thus, the chip may include the tiles and digital processing circuitry described above. In some embodiments, for a model having up to 10 8-bit weights, and when operating at 100 GOPs/sec on time series data, the chip may achieve power efficiency of 4 GOPs/milliwatt, measured at 40 degrees Celsius, when the chip uses supply voltages between 0.5-1.8V, and when the chip is performing operations without idling. In some embodiments, in addition to such a chip, any of the ear-worn devices described herein may include a digital signal processor configured to perform other processing operations.

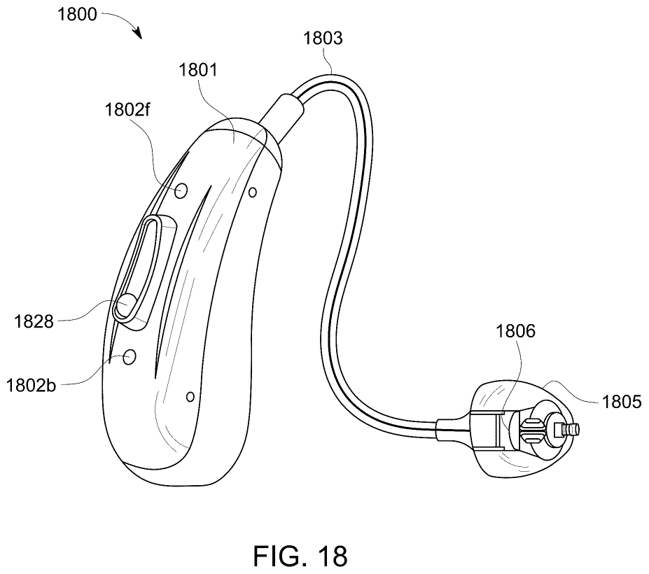

FIG. 18 illustrates a hearing aid 1800, in accordance with certain embodiments described herein. The hearing aid 1800 may be an example of any of the ear-worn devices or hearing aids described herein. The hearing aid 1800 is a receiver-in-canal (RIC) (also referred to as a receiver-in-the-ear (RITE)) type of hearing aid. However, any other type of hearing aid (e.g., behind-the-ear, in-the-ear, in-the-canal, completely-in-canal, open fit, etc.) may also be used. The hearing aid 1800 includes a body 1801, a receiver wire 1803, a receiver 1806 (which may correspond to the receiver 106), and a dome 1805. The body 1801 is coupled to the receiver wire 1803 and the receiver wire 1803 is coupled to the receiver 1806. The dome 1805 is placed over the receiver 1806. The body 1801 includes a front microphone 1802f, a back microphone 1802b, and a user input device 1828. (The front microphone 1802f and the back microphone 1802b may correspond to the one or more microphones 102) The body 1801 additionally includes circuitry (e.g., any of the circuitry described above, aside from the receiver 1806) not illustrated in FIG. 18. When the hearing aid 1800 is worn, the front microphone 1802f may be closer to the front of the wearer and the back microphone 1802b may be closer to the back of the wearer. The front microphone 1802f and the back microphone 1802b may be configured to receive sound signals and generate audio signals based on the sound signals. Any of the microphones described herein may be the front microphone 1802f and/or the back microphone 1802b of the hearing aid 1800. The user input device 1828 (which may correspond to the user input device 128) may be configured to control certain functions of the hearing aid 1800, such as switching modes.

The receiver wire 1803 may be configured to transmit audio signals from the body 1801 to the receiver 1806. The receiver 1806 may be configured to receive audio signals (i.e., those audio signals generated by the body 1801 and transmitted by the receiver wire 1803) and generate sound signals based on the audio signals. The dome 1805 may be configured to fit tightly inside the wearer's ear and direct the sound signal produced by the receiver 1806 into the ear canal of the wearer.

In some embodiments, the length of the body 1801 may be equal to 2 cm, equal to 5 cm, or between 2 and 5 cm in length. In some embodiments, the weight of the hearing aid 1800 may be less than 4.5 grams. In some embodiments, the spacing between the microphones may be equal to 5 mm, equal to 12 mm, or between 5 and 12 mm. In some embodiments, the body 1801 may include a battery (not visible in FIG. 18), such as a lithium ion rechargeable coin cell battery.

This disclosure includes, at least, the following examples:

Example A1 is directed to an ear-worn device, comprising: processing circuitry comprising: neural network circuitry configured to implement one or more first neural network layers or one or more second neural network layers; and control circuitry configured to control the processing circuitry to operate using a first configuration or a second configuration, wherein: the neural network circuitry is configured to implement the one or more first neural network layers when the processing circuitry operates using the first configuration; the first configuration has a first data processing latency; the neural network circuitry is configured to implement the one or more second neural network layers when the processing circuitry operates using the second configuration; and the second configuration has a second data processing latency different from the first data processing latency.

Example A2 is directed to the ear-worn device of claim A1, further comprising a user input device, and wherein the control circuitry is configured to control the processing circuitry to operate using the first configuration or the second configuration based on user activation of the user input device.

Example A3 is directed to the ear-worn device of any of claims A1-A2, further comprising communication circuitry configured to receive an indication from a processing device, and wherein the control circuitry is configured to control the processing circuitry to operate using the first configuration or the second configuration based on the indication received from the processing device.

Example A4 is directed to a system, comprising: the ear-worn device of claim A3; and the processing device, wherein the processing device is configured to generate the indication based on a user selection from a graphical user interface displayed by the processing device.

Example A5 is directed to the ear-worn device of any of claims A1-A4, further comprising monitoring circuitry, and wherein the control circuitry is configured to control the processing circuitry to operate using the first configuration or the second configuration based on a determination performed by the monitoring circuitry.

Example A6 is directed to the ear-worn device of claim A5, wherein the determination comprises a measurement of an ambient volume in an environment.

Example A7 is directed to the ear-worn device of claim A6, wherein: the control circuitry is configured to control the processing circuitry to switch between operating using the first configuration and operating using the second configuration when the ambient volume crosses a threshold.

Example A8 is directed to the ear-worn device of claim A6, wherein: the first data processing latency is shorter than the second data processing latency; and the control circuitry is configured to control the processing circuitry to switch from operating using the first configuration to operating using the second configuration when the ambient volume rises above a threshold.

Example A9 is directed to the ear-worn device of claim A5, wherein the determination comprises a measurement of a signal-to-noise ratio of an environment.

Example A10 is directed to the ear-worn device of claim A9, wherein: the control circuitry is configured to control the processing circuitry to switch between operating using the first configuration and operating using the second configuration when the signal-to-noise ratio crosses a threshold.

Example A11 is directed to the ear-worn device of claim A9, wherein: the first data processing latency is shorter than the second data processing latency; and the control circuitry is configured to control the processing circuitry to switch from operating using the first configuration to operating using the second configuration when the signal-to-noise ratio falls below a threshold.

Example A12 is directed to the ear-worn device of claim A5, wherein the determination comprises a determination of a presence of an own-voice signal or a level of the own-voice signal.

Example A13 is directed to the ear-worn device of claim A12, wherein: the first data processing latency is shorter than the second data processing latency; and the control circuitry is configured to control the processing circuitry to switch from operating using the second configuration to operating using the first configuration when the own-voice signal is detected or when the level of the own-voice signal exceeds a threshold.

Example A14 is directed to the ear-worn device of claim A1, wherein: the control circuitry is configured to control the processing circuitry to switch between operating using the second configuration and operating using the first configuration based on own-voice detection.

Example A15 is directed to the ear-worn device of any of claims A1-A14, wherein the processing circuitry is configured to: capture overlapping frames of input data using a frame size and a step size; generate neural network-based results from the overlapping frames of input data; and combine a number of the neural network-based results to generate each frame of output data.

Example A16 is directed to the ear-worn device of claim A15, wherein the processing circuitry is configured, when combining the number of the neural network-based results, to combine portions of the neural network-based results.

Example A17 is directed to the ear-worn device of claim A16, wherein the processing circuitry is configured, when combining the portions of the neural network-based results, to add the portions of the neural network-based results.

Example A18 is directed to the ear-worn device of claim A17, wherein the processing circuitry is configured, when adding the portions of the neural network-based results, to add the portions of the neural network-based results using time-shifting.

Example A19 is directed to the ear-worn device of any of claims A15-A18, wherein the processing circuitry is configured, when combining the number of the neural network-based results, to perform one or more overlap-add operations.

Example A20 is directed to the ear-worn device of any of claims A15-A19, wherein the processing circuitry is configured, when generating the neural network-based results from the overlapping frames of input data, to generate one neural network-based result from each of the overlapping frames of input data.

Example A21 is directed to the ear-worn device of any of claims A15-A20, wherein the neural network-based results comprise enhanced audio signals generated using neural network-generated masks.

Example A22 is directed to the ear-worn device of any of claims A15-A21, wherein the output data comprises enhanced audio signals.

Example A23 is directed to the ear-worn device of any of claims A15-A22, wherein: the processing circuitry is configured: to use a same frame size and a same step size for the first configuration and the second configuration; and to generate the output data from a first number of the neural network-based results when operating in the first configuration and to generate the output data from a second number of the neural network-based results when operating in the second configuration.

Example A24 is directed to the ear-worn device of claim A23, wherein the processing circuitry is configured to share at least one stage of data processing when operating in the first configuration and the second configuration.

Example A25 is directed to the ear-worn device of claim A24, wherein the at least one stage comprises performing a short-time Fourier transformation.

Example A26 is directed to the ear-worn device of any of claims A23-A25, wherein: the one or more first neural network layers comprise one or more shared layers and one or more first non-shared layers; and the one or more second neural network layers comprise the one or more shared layers and one or more second non-shared layers; the one or more first non-shared layers are trained based on generating the output data from the first number of the neural network-based results; and the one or more second non-shared layers are trained based on generating the output data from the second number of the neural network-based results.

Example A27 is directed to the ear-worn device of any of claims A15-A22, wherein: the processing circuitry is configured to use a first combination of frame size, step size, and number of neural network-based results used to generate each frame of the output data when operating in the first configuration; the first data processing latency is based, at least in part, on the first combination of frame size, step size, and number of neural network-based results used to generate each frame of the output data; the processing circuitry is configured to use a second combination of frame size, step size, and number of neural network-based results used to generate each frame of the output data when operating in the second configuration; and the second data processing latency is based, at least in part, on the second combination of frame size, step size, and number of neural network-based results used to generate each frame of the output data.

Example A28 is directed to the ear-worn device of claim A27, wherein the first combination has a shorter frame size than the second combination, and the first data processing latency is shorter than the second data processing latency.

Example A29 is directed to the ear-worn device of any of claims A27-A28, wherein the first combination has a smaller number of neural network-based results used to generate each frame of the output data than the second combination, and the first data processing latency is shorter than the second data processing latency.

Example A30 is directed to the ear-worn device of any of claims A27-A29, wherein the first combination comprises a frame size equal to 64 samples, equal to 192 samples, or between 64 and 192 samples.

Example A31 is directed to the ear-worn device of any of claims A27-A29, wherein the second combination comprises a frame size equal to 192 samples, equal to 320 samples, or between 192 and 320 samples.

Example A32 is directed to the ear-worn device of any of claims A27-A29, wherein the first combination comprises a frame size between 64 and 192 samples and the second combination comprises a frame size between 192 and 320 samples, and the first data processing latency is shorter than the second data processing latency.

Example A33 is directed to the ear-worn device of any of claims A27-A32, wherein the first combination comprises a number of neural network-based results used to generate each frame of the output data equal to 1, 2, 3, or 4.

Example A34 is directed to the ear-worn device of any of claims A27-A33, wherein the second combination comprises a number of neural network-based results used to generate each frame of the output data equal to 5, 6, 7, or 8.

Example A35 is directed to the ear-worn device of any of claims A27-A32, wherein the first combination comprises a number of neural network-based results used to generate each frame of the output data equal to 1, 2, or 3 and the second combination comprises a number of neural network-based results used to generate each frame of the output data equal to 4, 5, or 6, and the first data processing latency is shorter than the second data processing latency.

Example A36 is directed to the ear-worn device of any of claims A27-A32, wherein the first combination comprises a number of neural network-based results used to generate each frame of the output data equal to 1, 2, 3, or 4 and the second combination comprises a number of neural network-based results used to generate each frame of the output data equal to 5, 6, 7, or 8, and the first data processing latency is shorter than the second data processing latency.

Example A37 is directed to the ear-worn device of any of claims A1-A14, wherein: the processing circuitry is configured to: receive at least one frame N of data; generate, using the neural network circuitry, a mask based on the at least one frame N of data; apply the mask to a frame N-M of data, where M is greater than or equal to zero; and use a first value for M when operating in the first configuration and a second value for M when operating in the second configuration.

Example A38 is directed to the ear-worn device of claim A37, wherein in at least one of the first configuration and the second configuration, the frame N-M of data is received before the frame N of data.

Example A39 is directed to the ear-worn device of any of claims A37-A38, wherein in at least one of the first configuration and the second configuration, the frame N is a same frame as the frame N-M.

Example A40 is directed to the ear-worn device of any of claims A37-A39, wherein the first data processing latency is shorter than the second data processing latency, and the first value for M is less than the second value for M.

Example A41 is directed to the ear-worn device of any of claims A37-A40, wherein the first value for M is zero.

Example A42 is directed to the ear-worn device of any of claims A37-A41, wherein: the processing circuitry is configured, when receiving the at least one frame N of data, to receive the frame N of data and the frame N-M of data; and the processing circuitry is configured, when generating the mask based on the at least one frame N of data, to generate the mask based on the frame N of data and the frame N-M of data.

Example A43 is directed to the ear-worn device of any of claims A37-A42, wherein: the processing circuitry is configured, when receiving the at least one frame N of data, to receive frames N through N-M of data; and the processing circuitry is configured, when generating the mask based on the at least one frame N of data, to generate the mask based on the frames N through N-M of data.

Example A44 is directed to the ear-worn device of any of claims A1-A43, wherein the one or more first neural network layers and the one or more second neural network layers are trained to generate one or more outputs configured to generate audio signals having reduced background noise.

Example A45 is directed to the ear-worn device of claim A44, wherein the one or more outputs comprise one or more masks.

Example A46 is directed to the ear-worn device of any of claims A1-A43, wherein the one or more first neural network layers and the one or more second neural network layers are trained to generate one or more outputs configured to generate audio signals having spatial focus.

Example A47 is directed to the ear-worn device of claim A46, wherein the one or more outputs comprise one or more masks.

Example A48 is directed to the ear-worn device of any of claims A1-A43, wherein the one or more first neural network layers and the one or more second neural network layers are trained to generate one or more outputs configured to generate audio signals having reduced background noise and spatial focus.

Example A49 is directed to the ear-worn device of claim A48, wherein the one or more outputs comprise one or more masks.

Example A50 is directed to the ear-worn device of any of claims A1-A49, wherein the first data processing latency is equal to 4 milliseconds, equal to 10 milliseconds, or between 4 and 10 milliseconds.

Example A51 is directed to the ear-worn device of any of claims A1-A50, wherein the second data processing latency is equal to 10 milliseconds, equal to 14 milliseconds, or between 10 and 14 milliseconds.

Example A52 is directed to the ear-worn device of any of claims A1-A49, wherein the first data processing latency is between 4 and 10 milliseconds and the second data processing latency is between 10 and 14 milliseconds.

Example A53 is directed to the ear-worn device of any of claims A1-A52, wherein the one or more first neural network layers and the one or more second neural network layers have different weights and a same topology.

Example A54 is directed to the ear-worn device of any of claims A1-A52, wherein the one or more first neural network layers and the one or more second neural network layers have different topologies.

Example A55 is directed to the ear-worn device of any of claims A1-A54, wherein the one or more first neural network layers have an initial layer with a first input size and the one or more second neural network layers have an initial layer with a second input size different from the first input size.

Example A55b is directed to the ear-worn device of any of claims A1-A55, wherein the one or more first neural network layers have a final layer with a first output size and the one or more second neural network layers have a final layer with a second output size different from the first output size.

Example A56 is directed to the ear-worn device any of claims A12-A22, wherein: the processing circuitry is configured to: use a first frame size when operating in the first configuration; and use a second frame size when operating in the second configuration; the one or more first neural network layers have an initial layer with a first input size and a final layer with a first output size, and the first input size and the first output size are based, at least in part, on the first frame size; and the one or more first neural network layers have an initial layer with a second input size and a final layer with a second output size, and the second input size and the second output size are based, at least in part, on the second frame size, and are different from the first input size and the first output size, respectively.

Example A57 is directed to the ear-worn device of any of claims A1-A56, wherein: the control circuitry is configured, when controlling the processing circuitry to operate using the first configuration or the second configuration, to control the processing circuitry to switch from operating using the first configuration to operating using the second configuration.

Example A58 is directed to the ear-worn device of claim A57, wherein: the processing circuitry is configured to use a first pipeline when operating using the first configuration and to use a second pipeline when operating using the second configuration; the first pipeline and the second pipeline are configured to run simultaneously during a transition period when the processing circuitry switches from operating using the first configuration to operating using the second configuration.

Example A59 is directed to the ear-worn device of claim A58, wherein the processing circuitry is configured to combine a first output from the first pipeline and a second output from the second pipeline.

Example A60 is directed to the ear-worn device of claim A59, wherein: the processing circuitry is configured, when combining the first output from the first pipeline and the second output from the second pipeline, to use a first weight for the first output and a second weight for the second output; the first weight and the second weight are different during at least one time in the transition period; and the first weight and the second weight change during the transition period.

Example A61 is directed to the ear-worn device of claim A60, wherein the first weight decreases and the second weight increases during the transition period.

Example A62 is directed to the ear-worn device of claim A57, wherein: the processing circuitry is configured to use a first pipeline when operating using the first configuration and to use a second pipeline when operating using the second configuration; the control circuitry is configured to: detect a period when there is no speech; and control the processing circuitry to switch from operating using the first configuration to operating using the second configuration during a transition period, wherein the transition period is during, or at least starts during, the period when there is no speech.

Example A63 is directed to the ear-worn device of claim A62, wherein the processing circuitry is configured to: combine a first output from the first pipeline and an attenuated version of an input audio signal during a first portion of the transition period; and combine the attenuated version of the input audio signal and a second output from the second pipeline during a second portion of the transition period subsequent to the first portion.

Example A64 is directed to the ear-worn device of claim A63, wherein: the processing circuitry is configured, when combining the first output from the first pipeline and the attenuated version of the input audio signal, to use a first weight for the first output and a second weight for the attenuated version of the input audio signal; the first weight and the second weight are different during at least one time in the first portion of the transition period; and the first weight and the second weight change during the first portion of the transition period.

Example A65 is directed to the ear-worn device of claim A64, wherein the first weight decreases and the second weight increases during the first portion of the transition period.

Example A66 is directed to the ear-worn device of any of claims A64-A65, wherein: the processing circuitry is configured, when combining the attenuated version of the input audio signal and the second output from the second pipeline, to use a third weight for the attenuated version of the input audio signal and a fourth weight for the second output; the third weight and the fourth weight are different during at least one time in the second portion of the transition period; and the third weight and the fourth weight change during the second portion of the transition period.

Example A67 is directed to the ear-worn device of claim A66, wherein the third weight decreases and the fourth weight increases during the second portion of the transition period.

Example A68 is directed to the ear-worn device of claim A57, wherein: the first data processing latency is shorter than the second data processing latency; and the processing circuitry is configured to generate multiple outputs for at least one time segment.

Example A69 is directed to the ear-worn device of claim A57 or claim A68, wherein: the first data processing latency is higher than the second data processing latency; and the processing circuitry is configured to skip generating outputs for at least one time segment.

Example A70 is directed to the ear-worn device of any of claims A1-A69, wherein: the one or more first neural network layers comprise one or more shared layers and one or more first non-shared layers; and the one or more second neural network layers comprise the one or more shared layers and one or more second non-shared layers.

Example A71 is directed to the ear-worn device of claim A70, wherein the one or more first non-shared layers are trained based on a first number of neural network-based results to generate each frame of output data and the one or more second non-shared layers are trained based on a second number of neural network-based results to generate each frame of the output data.

Example B1 is directed to an ear-worn device, comprising: processing circuitry comprising: neural network circuitry configured to implement one or more first neural network layers or one or more second neural network layers; and control circuitry configured to control the processing circuitry to switch from operating using a first configuration to operating using a second configuration, wherein: the neural network circuitry is configured to implement the one or more first neural network layers when the processing circuitry operates using the first configuration; and the neural network circuitry is configured to implement the one or more second neural network layers when the processing circuitry operates using the second configuration.

Example B2 is directed to the ear-worn device of claim B1, wherein: the processing circuitry is configured to use a first pipeline when operating using the first configuration and to use a second pipeline when operating using the second configuration; the first pipeline and the second pipeline are configured to run simultaneously during a transition period when the processing circuitry switches from operating using the first configuration to operating using the second configuration.

Example B3 is directed to the ear-worn device of claim B2, wherein the processing circuitry is configured to combine a first output from the first pipeline and a second output from the second pipeline.

Example B4 is directed to the ear-worn device of claim B3, wherein: the processing circuitry is configured, when combining the first output from the first pipeline and the second output from the second pipeline, to use a first weight for the first output and a second weight for the second output; the first weight and the second weight are different during at least one time in the transition period; and the first weight and the second weight change during the transition period.

Example B5 is directed to the ear-worn device of claim B4, wherein the first weight decreases and the second weight increases during the transition period.

Example B6 is directed to the ear-worn device of claim B1, wherein: the processing circuitry is configured to use a first pipeline when operating using the first configuration and to use a second pipeline when operating using the second configuration; the control circuitry is configured to: detect a period when there is no speech; and control the processing circuitry to switch from operating using the first configuration to operating using the second configuration during a transition period, wherein the transition period is during, or at least starts during, the period when there is no speech.

Example B7 is directed to the ear-worn device of claim B6, wherein the processing circuitry is configured to: combine a first output from the first pipeline and an attenuated version of an input audio signal during a first portion of the transition period; and combine the attenuated version of the input audio signal and a second output from the second pipeline during a second portion of the transition period subsequent to the first portion.

Example B8 is directed to the ear-worn device of claim B7, wherein: the processing circuitry is configured, when combining the first output from the first pipeline and the attenuated version of the input audio signal, to use a first weight for the first output and a second weight for the attenuated version of the input audio signal; the first weight and the second weight are different during at least one time in the first portion of the transition period; and the first weight and the second weight change during the first portion of the transition period.

Example B9 is directed to the ear-worn device of claim B8, wherein the first weight decreases and the second weight increases during the first portion of the transition period.

Example B10 is directed to the ear-worn device of any of claims B7-B9, wherein: the processing circuitry is configured, when combining the attenuated version of the input audio signal and the second output from the second pipeline, to use a third weight for the attenuated version of the input audio signal and a fourth weight for the second output; the third weight and the fourth weight are different during at least one time in the second portion of the transition period; and the third weight and the fourth weight change during the second portion of the transition period.

Example B11 is directed to the ear-worn device of claim B10, wherein the third weight decreases and the fourth weight increases during the second portion of the transition period.

Example B12 is directed to the ear-worn device of claim B1, wherein: the first data processing latency is shorter than the second data processing latency; and the processing circuitry is configured to generate multiple outputs for at least one time segment.

Example B13 is directed to the ear-worn device of claim B1 or claim B12, wherein: the first data processing latency is higher than the second data processing latency; and the processing circuitry is configured to skip generating outputs for at least one time segment.

Example B14 is directed to the ear-worn device of any of claims B1-B13, wherein: the one or more first neural network layers comprise one or more shared layers and one or more first non-shared layers; and the one or more second neural network layers comprise the one or more shared layers and one or more second non-shared layers.

Example C1 is directed to an ear-worn device, comprising: processing circuitry comprising: neural network circuitry configured to implement one or more neural network layers; and control circuitry configured to control the processing circuitry to operate using a first configuration or a second configuration, wherein: the first configuration has a first data processing latency; and the second configuration has a second data processing latency different from the first data processing latency.

Example C2 is directed to the ear-worn device of claim C1, further comprising a user input device, and wherein the control circuitry is configured to control the processing circuitry to operate using the first configuration or the second configuration based on user activation of the user input device.

Example C3 is directed to the ear-worn device of any of claims C1-C2, further comprising communication circuitry configured to receive an indication from a processing device, and wherein the control circuitry is configured to control the processing circuitry to operate using the first configuration or the second configuration based on the indication received from the processing device.

Example C4 is directed to a system, comprising: the ear-worn device of claim C3; and the processing device, wherein the processing device is configured to generate the indication based on a user selection from a graphical user interface displayed by the processing device.

Example C5 is directed to the ear-worn device of any of claims C1-C4, further comprising monitoring circuitry, and wherein the control circuitry is configured to control the processing circuitry to operate using the first configuration or the second configuration based on a determination performed by the monitoring circuitry.

Example C6 is directed to the ear-worn device of claim C5, wherein the determination comprises a measurement of an ambient volume in an environment.

Example C7 is directed to the ear-worn device of claim C6, wherein: the control circuitry is configured to control the processing circuitry to switch between operating using the first configuration and operating using the second configuration when the ambient volume crosses a threshold.

Example C8 is directed to the ear-worn device of claim C6, wherein: the first data processing latency is shorter than the second data processing latency; and the control circuitry is configured to control the processing circuitry to switch from operating using the first configuration to operating using the second configuration when the ambient volume rises above a threshold.

Example C9 is directed to the ear-worn device of claim C5, wherein the determination comprises a measurement of a signal-to-noise ratio of an environment.

Example C10 is directed to the ear-worn device of claim C9, wherein: the control circuitry is configured to control the processing circuitry to switch between operating using the first configuration and operating using the second configuration when the signal-to-noise ratio crosses a threshold.

Example C11 is directed to the ear-worn device of claim C9, wherein: the first data processing latency is shorter than the second data processing latency; and the control circuitry is configured to control the processing circuitry to switch from operating using the first configuration to operating using the second configuration when the signal-to-noise ratio falls below a threshold.

Example C12 is directed to the ear-worn device of claim C5, wherein the determination comprises a determination of a presence of an own-voice signal or a level of the own-voice signal.

Example C13 is directed to the ear-worn device of claim C12, wherein: the first data processing latency is shorter than the second data processing latency; and the control circuitry is configured to control the processing circuitry to switch from operating using the second configuration to operating using the first configuration when the own-voice signal is detected or when the level of the own-voice signal exceeds a threshold.

Example C14 is directed to the ear-worn device of claim C1, wherein: the control circuitry is configured to control the processing circuitry to switch between operating using the second configuration to operating using the first configuration based on own-voice detection.

Example C15 is directed to the ear-worn device of any of claims C1-C14, wherein the processing circuitry is configured to: capture overlapping frames of input data using a frame size and a step size; generate neural network-based results from the overlapping frames of input data; and combine a number of the neural network-based results to generate output data.

Example C16 is directed to the ear-worn device of claim C15, wherein the processing circuitry is configured, when combining the number of the neural network-based results, to combine portions of the neural network-based results.

Example C17 is directed to the ear-worn device of claim C16, wherein the processing circuitry is configured, when combining the portions of the neural network-based results, to add the portions of the neural network-based results.

Example C18 is directed to the ear-worn device of claim C17, wherein the processing circuitry is configured, when adding the portions of the neural network-based results, to add the portions of the neural network-based results using time-shifting.

Example C19 is directed to the ear-worn device of any of claims C15-C18, wherein the processing circuitry is configured, when combining the number of the neural network-based results, to perform one or more overlap-add operations.

Example C20 is directed to the ear-worn device of any of claims C15-C19, wherein the processing circuitry is configured, when generating the neural network-based results from the overlapping frames of input data, to generate one neural network-based result from each of the overlapping frames of input data.

Example C21 is directed to the ear-worn device of any of claims C15-C20, wherein the neural network-based results comprise enhanced audio signals generated using neural network-generated masks.

Example C22 is directed to the ear-worn device of any of claims C15-C21, wherein the output data comprises enhanced audio signals.

Example C23 is directed to the ear-worn device of any of claims C15-C22, wherein: the processing circuitry is configured: to use a same frame size and a same step size for the first configuration and the second configuration; and to generate the output data from a first number of neural network-based results when operating in the first configuration and to generate the output data from a second number of the neural network-based results when operating the second configuration.

Example C24 is directed to the ear-worn device of claim C23, wherein the processing circuitry is configured to share at least one stage of data processing when operating in the first configuration and the second configuration.

Example C25 is directed to the ear-worn device of claim C24, wherein the at least one stage comprises performing a short-time Fourier transformation.

Example C26 is directed to the ear-worn device of any of claims C15-C22, wherein: the processing circuitry is configured to use a first combination of frame size, step size, and number of neural network-based results used to generate each frame of the output data when operating in the first configuration; the first data processing latency is based, at least in part, on the first combination of frame size, step size, and number of neural network-based results used to generate each frame of the output data; the processing circuitry is configured to use a second combination of frame size, step size, and number of neural network-based results used to generate each frame of the output data when operating in the second configuration; and the second data processing latency is based, at least in part, on the second combination of frame size, step size, and number of neural network-based results used to generate each frame of the output data.

Example C27 is directed to the ear-worn device of claim C26, wherein the first combination has a shorter frame size than the second combination, and the first data processing latency is shorter than the second data processing latency.

Example C28 is directed to the ear-worn device of any of claims C26-C28, wherein the first combination has a smaller number of neural network-based results used to generate each frame of the output data than the second combination, and the first data processing latency is shorter than the second data processing latency.

Example C29 is directed to the ear-worn device of any of claims C26-C28, wherein the first combination comprises a frame size equal to 64 samples, equal to 192 samples, or between 64 and 192 samples.

Example C30 The ear-worn device of any of claims C26-C28, wherein the second combination comprises a frame size equal to 192 samples, equal to 320 samples, or between 192 and 320 samples.

Example C31 is directed to the ear-worn device of any of claims C26-C28, wherein the first combination comprises a frame size between 64 and 192 samples and the second combination comprises a frame size between 192 and 320 samples, and the first data processing latency is shorter than the second data processing latency.

Example C32 is directed to the ear-worn device of any of claims C26-C31, wherein the first combination comprises a number of neural network-based results used to generate each frame of the output data equal to 1, 2, 3, or 4

Example C33 is directed to the ear-worn device of any of claims C26-C32, wherein the second combination comprises a number of neural network-based results used to generate each frame of the output data equal to 5, 6, 7, or 8.

Example C34 is directed to the ear-worn device of any of claims C26-C31, wherein the first combination comprises a number of neural network-based results used to generate each frame of the output data equal to 1, 2, or 3 and the second combination comprises a number of neural network-based results used to generate each frame of the output data equal to 4, 5, or 6, and the first data processing latency is shorter than the second data processing latency.

Example C35 is directed to the ear-worn device of any of claims C26-C31, wherein the first combination comprises a number of neural network-based results used to generate each frame of the output data equal to 1, 2, 3, or 4 and the second combination comprises a number of neural network-based results used to generate each frame of the output data equal to 5, 6, 7, or 8, and the first data processing latency is shorter than the second data processing latency.

Example C36 is directed to the ear-worn device of any of claims C1-C14, wherein: the processing circuitry is configured to: receive at least one frame N of data; generate, using the neural network circuitry, a mask based on the at least one frame N of data; apply the mask to a frame N-M of data, where M is greater than or equal to zero; and use a first value for M when operating in the first configuration and a second value for M when operating in the second configuration.

Example C37 is directed to the ear-worn device of claim C36, wherein in at least one of the first configuration and the second configuration, the frame N-M of data is received before the frame N of data.

Example C38 is directed to the ear-worn device of any of claims C36-C37, wherein in at least one of the first configuration and the second configuration, the frame N is a same frame as the frame N-M.

Example C39 is directed to the ear-worn device of any of claims C36-C38, wherein the first data processing latency is shorter than the second data processing latency, and the first value for M is less than the second value for M.

Example C40 is directed to the ear-worn device of any of claims C36-C39, wherein the first value for M is zero.

Example C41 is directed to the ear-worn device of any of claims C36-C40, wherein: the processing circuitry is configured, when receiving the at least one frame N of data, to receive the frame N of data and the frame N-M of data; and the processing circuitry is configured, when generating the mask based on the at least one frame N of data, to generate the mask based on the frame N of data and the frame N-M of data.

Example C42 is directed to the ear-worn device of any of claims C36-C40, wherein: the processing circuitry is configured, when receiving the at least one frame N of data, to receive frames N through N-M of data; and the processing circuitry is configured, when generating the mask based on the at least one frame N of data, to generate the mask based on the frames N through N-M of data.

Example C43 is directed to the ear-worn device of any of claims C1-C42, wherein the one or more neural network layers are trained to generate one or more outputs configured to generate audio signals having reduced background noise.

Example C44 is directed to the ear-worn device of claim C43, wherein the one or more outputs comprise one or more masks.

Example C45 is directed to the ear-worn device of any of claims C1-C42, wherein the one or more neural network layers are trained to generate one or more outputs configured to generate audio signals having spatial focus.

Example C46 is directed to the ear-worn device of claim C45, wherein the one or more outputs comprise one or more masks.

Example C47 is directed to the ear-worn device of any of claims C1-C42, wherein the one or more neural network layers are trained to generate one or more outputs configured to generate audio signals having reduced background noise and spatial focus.

Example C48 is directed to the ear-worn device of claim C47, wherein the one or more outputs comprise one or more masks.

Example C49 is directed to the ear-worn device of any of claims C1-C48, wherein the first data processing latency is equal to 4 milliseconds, equal to 10 milliseconds, or between 4 and 10 milliseconds.

Example C50 is directed to the ear-worn device of any of claims C1-C49, wherein the second data processing latency is equal to 10 milliseconds, equal to 14 milliseconds, or between 10 and 14 milliseconds.

Example C51 is directed to the ear-worn device of any of claims C1-C48, wherein the first data processing latency is between 4 and 10 milliseconds and the second data processing latency is between 10 and 14 milliseconds.

Example C52 is directed to the ear-worn device of any of claims C1-C51, wherein: the control circuitry is configured, when controlling the processing circuitry to operate using the first configuration or the second configuration, to control the processing circuitry to switch from operating using the first configuration to operating using the second configuration.

Example C53 is directed to the ear-worn device of claim C52, wherein: the processing circuitry is configured to use a first pipeline when operating using the first configuration and to use a second pipeline when operating using the second configuration; the first pipeline and the second pipeline are configured to run simultaneously during a transition period when the processing circuitry switches from operating using the first configuration to operating using the second configuration.

Example C54 is directed to the ear-worn device of claim C53, wherein the processing circuitry is configured to combine a first output from the first pipeline and a second output from the second pipeline.

Example C55 is directed to the ear-worn device of claim C54, wherein: the processing circuitry is configured, when combining the first output from the first pipeline and the second output from the second pipeline, to use a first weight for the first output and a second weight for the second output; the first weight and the second weight are different during at least one time in the transition period; and the first weight and the second weight change during the transition period.

Example C56 is directed to the ear-worn device of claim C55, wherein the first weight decreases and the second weight increases during the transition period.

Example C57 is directed to the ear-worn device of claim C52, wherein: the processing circuitry is configured to use a first pipeline when operating using the first configuration and to use a second pipeline when operating using the second configuration; the control circuitry is configured to: detect a period when there is no speech; and control the processing circuitry to switch from operating using the first configuration to operating using the second configuration during a transition period, wherein the transition period is during, or at least starts during, the period when there is no speech.

Example C58 is directed to the ear-worn device of claim C57, wherein the processing circuitry is configured to: combine a first output from the first pipeline and an attenuated version of an input audio signal during a first portion of the transition period; and combine the attenuated version of the input audio signal and a second output from the second pipeline during a second portion of the transition period subsequent to the first portion.

Example C59 is directed to the ear-worn device of claim C58, wherein: the processing circuitry is configured, when combining the first output from the first pipeline and the attenuated version of the input audio signal, to use a first weight for the first output and a second weight for the attenuated version of the input audio signal; the first weight and the second weight are different during at least one time in the first portion of the transition period; and the first weight and the second weight change during the first portion of the transition period.

Example C60 is directed to the ear-worn device of claim C59, wherein the first weight decreases and the second weight increases during the first portion of the transition period.

Example C61 is directed to the ear-worn device of any of claims C58-C60, wherein: the processing circuitry is configured, when combining the attenuated version of the input audio signal and the second output from the second pipeline, to use a third weight for the attenuated version of the input audio signal and a fourth weight for the second output; the third weight and the fourth weight are different during at least one time in the second portion of the transition period; and the third weight and the fourth weight change during the second portion of the transition period.

Example C62 is directed to the ear-worn device of claim C61, wherein the first weight decreases and the second weight increases during the second portion of the transition period.

Example C63 is directed to the ear-worn device of claim C62, wherein: the first data processing latency is shorter than the second data processing latency; and the processing circuitry is configured to generate multiple outputs for at least one time segment.

Example C64 is directed to the ear-worn device of claim C52 or claim C63, wherein: the first data processing latency is higher than the second data processing latency; and the processing circuitry is configured to skip generating outputs for at least one time segment.

Having described several embodiments of the techniques in detail, various modifications and improvements will readily occur to those skilled in the art. Such modifications and improvements are intended to be within the spirit and scope of the invention. Accordingly, the foregoing description is by way of example only, and is not intended as limiting. For example, any components described above may comprise hardware, software or a combination of hardware and software.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having described above several aspects of at least one embodiment, it is to be appreciated various alterations, modifications, and improvements will readily occur to those skilled in the art. Such alterations, modifications, and improvements are intended to be objects of this disclosure. Accordingly, the foregoing description and drawings are by way of example only.

1. An ear-worn device, comprising:
processing circuitry comprising:
neural network circuitry configured to implement one or more first neural network layers or one or more second neural network layers; and
control circuitry configured to control the processing circuitry to operate using a first configuration or a second configuration, wherein:
the neural network circuitry is configured to implement the one or more first neural network layers when the processing circuitry operates using the first configuration;
the first configuration has a first data processing latency;
the neural network circuitry is configured to implement the one or more second neural network layers when the processing circuitry operates using the second configuration; and
the second configuration has a second data processing latency different from the first data processing latency.

2. The ear-worn device of claim 1, further comprising communication circuitry configured to receive an indication from a processing device, and wherein the control circuitry is configured to control the processing circuitry to operate using the first configuration or the second configuration based on the indication received from the processing device.

3. The ear-worn device of claim 1, further comprising monitoring circuitry, and wherein the control circuitry is configured to control the processing circuitry to operate using the first configuration or the second configuration based on a determination performed by the monitoring circuitry.

4. The ear-worn device of claim 3, wherein the determination comprises a measurement of an ambient volume in an environment.

5. The ear-worn device of claim 4, wherein:
the control circuitry is configured to control the processing circuitry to switch between operating using the first configuration and operating using the second configuration when the ambient volume crosses a threshold.

6. The ear-worn device of claim 4, wherein:
the first data processing latency is shorter than the second data processing latency; and
the control circuitry is configured to control the processing circuitry to switch from operating using the first configuration to operating using the second configuration when the ambient volume rises above a threshold.

7. The ear-worn device of claim 3, wherein the determination comprises a measurement of a signal-to-noise ratio of an environment.

8. The ear-worn device of claim 7, wherein:
the control circuitry is configured to control the processing circuitry to switch between operating using the first configuration and operating using the second configuration when the signal-to-noise ratio crosses a threshold.

9. The ear-worn device of claim 7, wherein:
the first data processing latency is shorter than the second data processing latency; and
the control circuitry is configured to control the processing circuitry to switch from operating using the first configuration to operating using the second configuration when the signal-to-noise ratio falls below a threshold.

10. The ear-worn device of claim 3, wherein the determination comprises a determination of a presence of an own-voice signal or a level of the own-voice signal.

11. The ear-worn device of claim 10, wherein:
the first data processing latency is shorter than the second data processing latency; and
the control circuitry is configured to control the processing circuitry to switch from operating using the second configuration to operating using the first configuration when the own-voice signal is detected or when the level of the own-voice signal exceeds a threshold.

12. The ear-worn device of claim 1, wherein:
the control circuitry is configured to control the processing circuitry to switch between operating using the second configuration and operating using the first configuration based on own-voice detection.

13. The ear-worn device of claim 1, wherein the processing circuitry is configured to:
capture overlapping frames of input data using a frame size and a step size;
generate neural network-based results from the overlapping frames of input data;
combine a number of the neural network-based results to generate each frame of output data;
use a first combination of frame size, step size, and number of neural network-based results used to generate each frame of the output data when operating in the first configuration, wherein the first data processing latency is based, at least in part, on the first combination of frame size, step size, and number of neural network-based results used to generate each frame of the output data; and
the processing circuitry is configured to use a second combination of frame size, step size, and number of neural network-based results used to generate each frame of the output data when operating in the second configuration, wherein the second data processing latency is based, at least in part, on the second combination of frame size, step size, and number of neural network-based results used to generate each frame of the output data.

14. The ear-worn device of claim 13, wherein the first combination has a shorter frame size than the second combination, and the first data processing latency is shorter than the second data processing latency.

15. The ear-worn device of claim 13, wherein the first combination has a smaller number of neural network-based results used to generate each frame of the output data than the second combination, and the first data processing latency is shorter than the second data processing latency.

16. The ear-worn device of claim 13, wherein the first combination comprises a frame size between 64 and 192 samples and the second combination comprises a frame size between 192 and 320 samples.

17. The ear-worn device of claim 13, wherein the first combination comprises a number of neural network-based results used to generate each frame of the output data equal to 1, 2, or 3 and the second combination comprises a number of neural network-based results used to generate each frame of the output data equal to 4, 5, or 6.

18. The ear-worn device of claim 13, wherein the first combination comprises a number of neural network-based results used to generate each frame of the output data equal to 1, 2, 3, or 4 and the second combination comprises a number of neural network-based results used to generate each frame of the output data equal to 5, 6, 7, or 8.

19. The ear-worn device of claim 13, wherein:
the processing circuitry is configured to:
use a first frame size when operating in the first configuration; and
use a second frame size when operating in the second configuration;
the one or more first neural network layers have an initial layer with a first input size and a final layer with a first output size, and the first input size and the first output size are based, at least in part, on the first frame size; and
the one or more first neural network layers have an initial layer with a second input size and a final layer with a second output size, and the second input size and the second output size are based, at least in part, on the second frame size, and are different from the first input size and the first output size, respectively.

20. The ear-worn device of claim 1, wherein the first data processing latency is between 4 and 10 milliseconds and the second data processing latency is between 10 and 14 milliseconds.

21. The ear-worn device of claim 1, wherein the one or more first neural network layers have an initial layer with a first input size and the one or more second neural network layers have an initial layer with a second input size different from the first input size.

22. The ear-worn device of claim 1, wherein the one or more first neural network layers have a final layer with a first output size and the one or more second neural network layers have a final layer with a second output size different from the first output size.

23. The ear-worn device of claim 1, wherein:
the one or more first neural network layers comprise one or more shared layers and one or more first non-shared layers; and
the one or more second neural network layers comprise the one or more shared layers and one or more second non-shared layers.

24. The ear-worn device of claim 23, wherein the one or more first non-shared layers are trained based on a first number of neural network-based results to generate each frame of output data and the one or more second non-shared layers are trained based on a second number of neural network-based results to generate each frame of the output data.
